(19) United States
(12) Patent Application Publication
(10) Pub. No.: US 2008/0187086 A1
(43) Pub. Date: Aug. 7, 2008

(54) Method and apparatus for controlling charged particles

(75) Inventors: Robert W. Bussard, Santa Fe, NM (US); Dolly H. Gray-Bussard, Santa Fe, NM (US)

Correspondence Address: FOLEY AND LARDNER LLP;SUITE 500, 3000 K STREET NW, WASHINGTON, DC, 20007, US

(73) Assignee: EMC2

(21) Appl. No.: 11/905,183

(22) Filed: Sep. 27, 2007

Related U.S. Application Data
(63) Continuation-in-part of application No. 11/527,906, filed on Sep. 27, 2006.

(51) Int. Cl. H05H 1/02

(52) U.S. Cl. 376/127

(57) ABSTRACT

An apparatus and method for controlling charged particles. The charged particles comprise electrons and positive ions. A magnetic field having only point cusps is used to confine energetic injected electrons and so to generate a negative potential well. Positive ions injected into or created within the negative potential well are trapped therein. The magnetic field is generated by current-carrying elements arranged at positions spaced from but closely adjacent and parallel to edges of a polyhedron which has an even number of faces surrounding each vertex or corner. The current-carrying elements are spaced apart at their corners (the vertices of the polyhedron) so as not to touch, and the containing structures for the current-carrying coils of the magnetic-field-providing system are conformal to the fields so produced. Preferably, the coils are placed on the outboard side of the confining coils so as to increases electron confinement.

### CROSS REFERENCE TO RELATED APPLICATION

This application is a continuation-in-part of U.S. patent application Ser. No. 11/527,906 filed on Sep. 27, 2006 and incorporated herein by reference in its entirety.

### STATEMENT OF GOVERNMENTAL INTEREST

The United States government has a royalty free license to the invention claimed herein for governmental purposes under the terms of the Department of Navy contract N68936-03-C-0031.

### BACKGROUND OF THE INVENTION

The invention pertains to a method and apparatus for controlling charged particles, and more particularly to a method and apparatus for confining ionized gases or plasmas.

Confinement of dense ionized gases is a necessary step in several processes which are currently the object of intense research. These processes include nuclear fusion. Research on the confinement and heating of ionized gases and of their electron and ionic charged particle gaseous components has concentrated principally on the methods of inertial confinement and magnetic confinement.

An example of non-magnetic and non-electric inertial confinement is the so-called “laser-fusion” process in which large pressures are to be induced over the surface of small spheres of material which it is desired to heat and confine by the vaporization and “blowoff” of surface material by laser light energy heating thereof. Such high pressures cause the compression and resulting compressional heating of the material within the small spheres. The principal difficulty of achieving useful fusion-reaction-producing conditions by such hydrodynamic-inertial confinement means is that of the lack of stability of compression, to the very high densities required, of small amounts of material in spherical or other convergent geometries. In such inertial-compression schemes it is necessary to create the forces and drive the compression sufficiently rapidly that radiation and electron conduction energy loss processes from the compressing plasma/material do not radiate and/or carry away the material internal energy before the desired particle energy (i.e., temperature) has been achieved. Typically, time scales of fractions of microseconds are required for such systems.

Attainable compression temperatures are limited by deviations from perfect symmetry of compression which lead to non-spherical compressed geometries, mixing of material, and other effects. Because of these requirements and physical difficulties such inertial-mechanical means for confining and heating plasma material have been shown to require large power input to the devices and machinery used for studies of such processes. This approach is of little interest in connection with and has no fundamental relevance to embodiments of the present invention, and will not be further considered.

In magnetic confinement methods, strong magnetic fields are used in various geometries in attempts to confine or hold plasmas in well-defined spatial regions for periods of time long enough to allow their heating to desired levels of plasma ion particle energy or temperature.

An example of a device which employs a magnetic confinement method is the tokamak. The tokamak has a toroidal magnetic confinement geometry in which plasma ions and electrons are to be held within a toroidal volume by the magnetic field lines which circle through that volume.

Another example of such a device is a mirror machine. A mirror machine uses a “mirror” geometry in which opposing (facing) magnet coils act to provide a high-field surface around a central volume at lower field strength. Use of similarly-directed currents in such end coils causes “end-plugging” of a solenoidal field configuration, while oppositely-directed currents give rise to a bi-conic mirror geometry around a region in which the central magnetic field strength can drop to zero. This latter arrangement is described in more detail below.

Charged particles (e.g., plasma ions and/or electrons) gyrate around (normal to) the magnetic field lines in all such systems, in orbits whose gyro radii are set by their individual particle charge, mass, and energy of motion transverse to the magnetic fields.

As just mentioned, one of the magnetic field geometries which have been studied for plasma confinement is the simple bi-conic mirror cusp geometry. Such a system is depicted in FIGS. 1A-1C. In this system two opposing coils 100 and 110 carrying oppositely-directed currents face (“mirror”) each other and produce a bipolar and equatorial field “cusp” geometry. The advantage of this system is that it is (i.e., has been shown to be) inherently stable to macroscopic “collective” losses of plasma across the field. This is in contrast to the toroidal tokamak and to the solenoidal mirror geometries which are not inherently stable to such losses. Losses in the bi-conic mirror system are principally out through the polar end cusps one of which is labeled 130, and the belt or equatorial “ring” cusp 135 of the magnetic field geometry. Particles 140 making up plasma 120 approach point cusp 130 from a range of angles. Most are deflected due to their having a nonaxial velocity component. Some particles, however, approach the cusp along paths which permits them to escape out through the cusp.

The total loss rate through these cusp regions is determined by the “loss cone angle” and by the solid angle (in velocity space) subtended by the leakage cusp system. The loss cone angle is set by the field strength in the current-carrying coils which make the field, and the solid angle is simply the result of the geometry chosen. In the bi-conic mirror system the losses are predominantly through the equatorial cusp 135 because of its great extent entirely surrounding the plasma region.

In experimental and theoretical work aimed at using such “mirror” field systems to confine plasmas, a remedy for this defect was attempted by twisting half the field through 90 degrees (so-called “baseball” geometry), so that the cusp leakage ring is split into orthogonal half-hemispheres. This has the effect of removing equatorial plane coherence for particles able to scatter out through the equatorial field ring loss angle. However, this twisting of the field half-space does not change the basic topology of the bi-conic system and, although still macroscopically stable, the plasma will continue to be lost predominantly through the (now-bifurcated) equatorial ring cusp in the confining field.

Studies have also been made of the solenoidal mirror geometry, in which end point cusps act as “reflectors” of particles at the ends of the quasi-solenoidal field system. As previously noted, however, the solenoidal field region itself and its connection regions to the end cusps are inherently macro-unstable with respect to plasma/field interchange displacements. Thus, while the ring cusp losses of the bi-conic cusp mirror geometry have been removed, they have been replaced by new losses due to instability of the basic central field configuration. In experimental and theoretical work on such systems a partial remedy for this defect was obtained by adding current-carrying conductors between the mirror coils, parallel to the coil system axis. These parallel conductors (sometimes called “loffe bars”, after their Soviet inventor) provide fields which yield longitudinal surface cusp geometries which are inherently stable, but which embody particle losses through the longitudinal line cusps thus formed between conductors. In addition, locally unstable regions still exist between the central longitudinal fields and the end mirror point cusps, which lead to enhanced losses.

The virtue of the simple bi-conic mirror cusp field system is that it is inherently macroscopically stable and is thus subject only to microscopic plasma loss phenomena (e.g., collisional guiding center transport). Its defect is the very large conical sector equatorial ring cusp loss region. Polar end point cusp losses can be made small in most systems of interest by use of large mirror field ratios (particle velocity-space loss cone angle is given by sin²θ=[B₀/Bₘ], where B₀ is field strength at the point where the plasma is “captured” by the polar cusp field (the “adiabatic capture” point) and Bₘ is maximum field strength on the mirror cusp axis). In addition, the point cusps can be used easily for injection of plasma ions and/or electrons into the central region of such a magnetic confinement geometry. A mirror system which contained only point cusps would provide an ideal stable field/confinement geometry.

Some efforts have been expended investigating other geometries for magnetic plasma confinement. One such effort is that of R. Keller and I. R. Jones, “Confinement d'un Plasma par un Systeme Polyedrique a′ Courant Alternatif”, Z. Naturforschg. Vol. 21 n, pp. 1085-1089 (1966). Octahedral and truncated cube systems were explored. These are labeled 200 and 230 in FIG. 2. Keller and Jones noted that the octadedron has two symmetry axes A and B. The truncated cube system, on the other hand, has three axes of symmetry C, D, and E. Keller and Jones experimentally explored neutral plasma heating and confinement by driving alternate interlaced coil sets at a (high) frequency of 4.7 MHz. It should be noted that the two interlaced fields used in this work were of opposite type, one being solenoidal and the other opposing bi-conical; thus alternation between field sets/states caused an inversion of field direction with each half cycle. It is not clear that alternation between such states is most effective for plasma confinement or heating. However, losses are greatly reduced from those of a conventional bi-conic equatorial ring cusp system of comparable size. Stable confinement was obtained at the experimental conditions, with modest heating observed, and the presence of a “spherical wave” was noted in the plasma.

Another extreme of magnetic confinement geometry is disclosed in U.S. Pat. No. 4,233,537 to Limpaecher. Therein it is proposed to confine neutral plasmas within a cylindrically symmetric volume whose surface contains an array of 1250 alternating magnetic poles, with axial electron injection to establish a negative plasma potential. In this system, plasma is to be confined by the surface magnetic multipole fields and constrained by the cylindrical interior negative electric potential field. In all of the arrangements considered there were always macroscopically unstable regions somewhere on the surface (e.g., at the end regions of the cylindrical volume), and the electrostatic field was never suggested as the primary or sole confinement field for plasma ions.

In both magnetic and inertial-confinement approaches the plasma heating is made to occur by statistically random collisional processes, either while under growing compression conditions or (with externally-driven energetic particles) while “trapped” for a sufficient length of time in a “confining” magnetic field geometry. It would appear to be desirable, however, to provide a more direct and non-statistical non-random process for energy addition to gain energy directly by “falling” through the negative electric potential which provides their confinement.

In the tokamak (and all other magnetic confinement systems) configuration, charged particles are lost from the system (to its walls) by transport of plasma ions and electrons across the magnetic fields by microscopic inter-particle collisions (which abruptly shift the particle gyration radius “guiding center”), and by other processes in which plasma particles, ions, and electrons act collectively to yield macroscopic transport losses of “groups” of particles across the supposed “confining” magnetic fields.

Microscopic inter-particle collisions are both inevitable and necessary in plasmas in which it is desired to achieve inter-particle nuclear reactions. Thus in a magnetic plasma confinement system of interest for the attainment of nuclear fusion reactions, it is inherently necessary that plasma particles be lost from the field geometry by collisional “jumping” of the gyro centers (above). Without collisions there can be no fusion (or other nuclear) reactions; thus the attainment of conditions for fusion reactions ensures that the magnetic field can not confine the plasma, but can only constrain its (inherent) loss rate.

In short, magnetic fields can confine (without losses) only plasmas and charged particle systems in which no collisions occur between particles. Since collisions will occur if two or more particles are in a given magnetic field system, it is evident that magnetic fields can not completely confine plasmas at densities of utility for nuclear fusion (or other nuclear) reaction production; they can only inhibit their unavoidable loss rate. In such systems the particle losses therefrom constitute an energy loss which must be made up by continuous injection of power to the system, in order to keep it operating at the desired conditions of plasma density and/or temperature. Research work to date in nuclear fusion has shown that considerable losses are inherent in the use of magnetic fields for plasma confinement.

In general it has been found that conceptual magnetic confinement systems for the production of useful fusion power generation must be very large when based on low-power-consumption magnet coils of super-conducting material. Alternatively it has been found that small tokamak systems with small power input to the plasma region can be based on magnet coils of normal-conducting materials but will require very large power input to drive these coils.

Thus, all conventional magnetic approaches to the generation of fusion power are practically unable to take advantage of the natural large energy gain (G=ratio of energy output to energy input per fusion reaction) inherent in the fusion process. This “natural” gain can be as large as G=2000 for the fusion of deuterium (D or ²H) and tritium (T or ³H), the two heavy isotopes of hydrogen (p or ¹H).

Furthermore, a magnetic field can not produce a force on a charged particle unless that particle is in motion. If it is at rest with respect to the system—and therefore not attempting to leave the system—it will not feel any force in a magnetic system. It will experience a force in such a system only if it is trying to escape from (or otherwise moving in) the system. When moving, the force exerted on such a charged particle by a magnetic field is not oppositely directed to its direction of motion, it is at right angles to its direction of motion. The magnetic force on such a moving particle is thus not a “restoring” force, it is a “deflecting” force. Because of this the field is relatively ineffective in holding neutral plasmas of equal numbers of charged particles together, as in tokamaks or mirror field geometries used in fusion research. This results in large power requirements for the machinery needed/used for confinement and plasma heating in such devices constructed according to these concepts, and the energy gain (G) potentially achievable is found to be limited by practical engineering considerations to the order of G.≈2 to 6.

Electrostatic systems have also been explored for the confinement of plasmas. The simplest such system is that with a spherical geometry, in which a negative potential is maintained at the center of a spherical shell by an electrode (cathode) mounted at the center. Positive ions introduced into such a geometry will be forced toward (and will “fall” to) the center until their mutual Coulombic repulsive forces exactly balance the inward-directed forces on them by the applied radial fields. In this “fall” the ions will acquire particle energies equal to the electric field potential drop. In principle, such systems offer very efficient means of reaching particle energies of interest for fusion reactions (efficiency of energy addition and thus to particle “heating” by this means is nearly 100%, which enables the achievement of very high gain G values). Of course, this method of energy addition does not constitute “heating” in that the ions so energized are all monoenergetic—there is no Maxwellian spread in their energy distribution. This is a distinct advantage when trying to use these ions to create fusion, as it is possible to tailor the energy to fit the desired reaction rate cross-section, without regard to the large number of particles in a Maxwellian distribution that are not at the desired energy. Unfortunately the ion densities which can be achieved by this means, described above, within the limits of externally-supplied electric fields which are practically attainable, are too small to be of interest for fusion plasma reaction production at a useful level.

The absolute density of ions in such an electrostatic system can be increased by the addition of electrons to such a system, to yield a (net) quasi-neutral plasma whose ion and electron densities are very nearly equal. However, it can be shown (Earnshaw's theorem) that a static (neutral) plasma can not be confined by an electrostatic field of this type. This is because the plasma ions and electrons will be subject to oppositely-directed forces in the static field and will separate, thus producing a local field gradient (due to their charge separation) which exactly cancels the applied field. In this condition the plasma can move across the field as fast as electrons are lost from its outer boundary. The speed of motion of electrons escaping from such a system is limited to that of ion motion, as the two oppositely-charged particles are tied together by their dielectric field. In a system with a static centrally-negative spherical electric field configuration, as described above, there is no force field to inhibit electron loss from the outer boundary or periphery of such a neutral plasma. Earnshaw's theorem applies only to static electrostatic systems, while those of interest here are based on dynamic motion of both species of particle, in which their respective kinetic energies are transformed into potential energy in the particle motion through the system. Here, Earnshaw's theorem is not applicable.

Previous workers have recognized the value of electrostatic forces for plasma/ion confinement. The earliest work was reported by William C. Elmore, James L. Tuck, and Kenneth M. Watson, “On the Inertial-Electrostatic Confinement of a Plasma”, Phys. Fluids, Vol. 2, No. 3, pp. 239-246 (May-June 1959). Elmore et al proposed to overcome the difficulty of the Earnshaw's theorem limit (mentioned above) through the generation of the desired spherical radial field by the injection of energetic electrons in a radially-inward direction. This is depicted in FIG. 3. In this pioneering work electrons were to be emitted from the inner surface of a spherical shell 300 through a (screen) grid 310 at high positive potential (100 kev). Electrons so injected would pass through the grid and converge radially to a central region 330 where their electrostatic potential at the sphere center was equal to the grid injection energy. This is the result of the transformation of electron kinetic energy into negative potential well energy. This large negative electrostatic potential, maintained by continuous electron injection (to make up losses) could then be used to trap positive ions in the system. Ions “dropped” into such a potential well would acquire energy at the “bottom” of the well (i.e., at the sphere center) equal to the negative potential established by the electron injection energy. This scheme obviously depends on the conversion of kinetic energy of injected electrons to negative electric potential fields and is thus an inertial-electrostatic method of plasma confinement. No means were provided to inhibit electron loss at the sphere surface, or to avoid electron collisional losses with the grid material, through which the electrons must pass twice in each circulation through the device.

Somewhat later it was shown that such a negative potential well system, involving only direct electron injection, with no means to stabilize the electron motion, against spatial perturbations, is unstable to various perturbations if the confined ion density exceeds a certain level. H. P. Furth, “Prevalent Instability of Nonthermal Plasma”, Phys. Fluids, Vol. 6, No. 1, pp. 48-53 (January 1963). This level was shown to be so low that the system was not of practical interest. Furth agreed with Elmore et al that the system would be unstable, and further showed that such self-confined inertial electron/ion systems using electrostatic confinement were inherently unstable. That is, systems in which confining non-equilibrium electrostatic fields are to be produced by inertial-electrostatic conversion of one charged component would be unstable above some critical density of the other component. For confinement by electron injection the ion density limit is too small to be of interest. But the further defect in this system is that, mentioned above, that the electrons must circulate through the accelerating grid twice in each pass through the system, and thus will strike the grid material and be lost (a large energy loss) at an excessive rate. It was shown that electrons must recirculate more than 100,000 times to yield an effective power balance in such a system, and this could happen only if the grid solidity was less than 1 part in 100,000-no practical grid can be constructed to this fine a specification. Experiments made by Farnsworth and others showed limiting solidity fractions of, at best, 1 part in 10-20.

Another system for electrostatic confinement of plasmas is set forth in U.S. Pat. Nos. 3,258,402 (Jun. 28, 1966) and 3,386,883 (Jun. 4, 1968) to P. T. Farnsworth. Following the approach further research has been conducted into the feasibility of electrostatic confinement of ions. See, e.g, Robert L. Hirsch, “Inertial-Electrostatic Confinement of Ionized Fusion Gases”, Jour. Appl. Phys, Vol. 38, No. 11 (October 1967). Hirsch also utilized conversion of inertial energy for the production of central electrostatic fields. His work followed along the lines developed by Farnsworth (above), and utilized spherical grid structures and geometries as outlined in his U.S. Pat. Nos. 3,530,036 and 3,530,497 (both Sep. 22, 1970). Hirsch used injected ions (of D and T) rather than electrons. The several-thousand-fold mass difference (ions heavier than electrons) allowed the attainment of much more stable field/ion structures than predicted for electron injection, and the devices tested by Hirsch achieved fusion reaction rates in excess of 1.0E10 reactions/second on a continuous basis.

However, the geometry which was used was not completely spherical; the ions were injected by six opposing ion guns mounted in opposite cubic-faced array. Later analysis suggests that this geometry as well as other conditions of the experiment caused intersecting beam phenomena and ion/gas collisions to dominate over other phenomenologies important to electrostatic confinement, as these were envisioned by Farnsworth and Hirsch in their earlier work. D.C. Baxter and G. W. Stuart, “The Effect of Charge Exchange and Ionization in Electrostatic Confinement Devices”, Jour. Appl. Phys., Vol. 53, No. 7, pp. 4597-4601 (July 1982). In particular, it appears that current amplification by multiple transits across the potential cavity did occur, with consequent beam buildup, in part due to reflection of ions by the grid structures opposing their own injector structures, as indicated by the sensitivity of neutron output to injection beam alignment. Here (as in the work of Elmore et al) no mechanism was invoked to provide any other confinement of electrons at the surface or periphery of the approximately-spherical system geometry. Still further analyses showed that the ion beams injected into these devices were cut off in radius by the “buttons” used to define the accelerating potential, so that increasing current led to only a first-order growth in ion density within the reacting central region (as opposed to a square relationship as determined by fundamental physics limitations), and that the devices were not scalable, because of the dimensional constraints of Paschen arc creation.

The use of electron injection to produce negative plasma potentials for enhanced confinement in magnetic systems was examined in Soviet work on magnetic mirror systems. Work of the Soviet group at Kharkov, as reported in the Annals of the New York Academy of Sciences, Vol. 251, the proceedings of a conference held Mar. 5-7, 1974 on Electrostatic and Electromagnetic Confinement of Plasmas and the Phenomenology of Relativistic Electron Beams, (L. C. Marshall and H. L. Sahlin, ed., 1975). See, for example, Levrent'ev “Electrostatic and electromagnetic High-Temperature Plasma Traps” and also Dolan “Electric-Magnetic Confinement”. These systems used physical ring electrodes in the ring cusp region of bi-conic cusp systems to inhibit plasma ion losses, and employed axial electron injection in cylindrical geometry to enhance ion magnetic confinement by producing negative potentials in the plasma region of this and of solenoidal loffe-bar-type mirror systems. Similar work by Blondin and Dolan invoked fixed cusp-region anode and cathode structures to aid magnetic cusp/mirror plasma ion confinement by the imposition of electrostatic fields in both the polar and equatorial loss cones. D. C. Blondin and T. J. Dolan, “Equilibrium Plasma Conditions in Electrostatically Plugged Cusps and Mirrors”, J. Appl. Phys., Vol. 47, No. 7, pp. 2903-2906 (July 1976). R. L. Hirsch had earlier studied this method to aid confinement in solenoidal mirror magnetic confinement systems. U.S. Pat. No. 3,655,508 (Apr. 11, 1972). Still other work utilized ion injection to establish positive potential fields in bi-conic or mirror cusp geometries, or in twisted bi-conic mirrors used as “plugs” at the ends of linear solenoids (See, e.g., F. L. Hinton and M. N. Rosenbluth, “Stabilization of Axisymmetric Mirror Plasmas by Energetic Ion Injection”, Nucl. Fus., Vol. 22, No. 12, pp. 1547-1557 (1982), and P. J. Catto and J. B. Taylor, “Electrostatic Enhancement of Mirror Confinement”, Nucl. Fus., Vol. 24, No. 2, pp 229-233 (1984).) All of these approaches used fixed electrodes and/or ion or electron injection to establish electric potentials to aid magnetic plasma confinement systems, not for the direct electrostatic confinement of ions.

Finally, the work of R. W. Bussard, based on U.S. Pat. No. 4,826,646, the contents of which are incorporated herein by reference in their entirety, invoked a combination of both electric and magnetic confinement, in which inherently macro-stable polyhedral magnetic fields were used to confine and hold energetic electrons. The electrons are injected through the cusps of the polyhedral field geometries, to form a deep negative potential well. Ions were injected (“dropped”) to fall into the well and circulate through the well, colliding at or near its center, and thus allowing fusion to occur there. This fusion is not thermal fusion since the ion distribution is not Maxwellian, so Maxwellian power balance arguments cannot be applied to this system. This arrangerment prevented losses due to ion/ion collisions that do not make fusion, by the fact that the ions return their energy to the electric potential of the well, as they circulate back up its sides, before falling back into the center again. Experimental and theoretical work conducted on this concept proceeded since 1990, and has shown the efficacy of this approach, to overcome the instabilities mentioned above and to avoid line-cusp losses as characterize all other attempts to use combined fields. A further description of this confinement technique is set forth in Krall, “The Polywell™: A Spherically Convergent Ion Focus Concept, Fusion Technology, Vol. 22, August 1992, the contents of which are hereby incorporated by reference in their entirety.

In summary, as determined by the present inventor, previous work in inertial, magnetic, and electrostatic confinement aimed at the confinement of charged particles (ions), for the purpose of creating conditions useful for the generation of nuclear fusion reactions between them, has shown that:
(1) Magnetic fields do not provide restoring forces to charged particles in motion, or to confine plasma particles; they provide deflecting forces, at right angles to the direction of motion of the particles. Electrostatic, electrodynamic, and other electric fields can provide direct restoring forces for the confinement of charged particles.
(2) Even the most favorable magnetic confinement geometries lose charged particles by gyro guiding center shifting due to microscopic collisions between particles. Such collisions are essential for the creation of nuclear reactions.
(3) Collisions between particles of like sign have the most effect on ion losses. Such collisional losses are governed by the gyro radii of ion/ion collisions in conventional magnetic confinement schemes. Electron gyro radii are very much less than those of ions of comparable energy.
(4) Electron and ion motions in magnetic fields are of opposite sign. This results in the electric polarization of the plasma, with the establishment of an ambipolar dielectric field. Plasma losses are then set by the rate of ion/ion transport collisions across the field, to the walls or structures of the system.
(5) Inertial-electrostatic potential wells established and maintained by charged particle injection alone and held solely within electric field structures are stable only for confinement at particle densities below a certain critical value. This is found to be too low for the production of nuclear fusion reaction rates useful for power generation.

### SUMMARY OF THE INVENTION

Considering all of these facts and features it appears that useful confinement of plasmas can be achieved by improvement on all prior concepts, by the new and unique uses and combinations of magnetic and electric fields discussed in U.S. Pat. No. 4,826,646, and mentioned above, and by use of inertial forces. However, this approach has been found to be practical only if the means for generating the confining magnetic fields is designed so that no electrons can ever “see” any direct path to the structures that comprise these means, else electrons losses—from their confined state—will prove excessive, and it will not be possible to overcome these losses sufficiently to make net power from fusion reactions from ions in a machine that allows such direct losses. Combined electric and magnetic fields, used in a polyhedral geometry, can both confine and energize (by injection of energetic electrons) ions to produce fusion reactions without excessive losses, provided that the means or structure for their confinement are properly arranged to avoid direct electron losses to the magnetic coil (or other) structures used to provide the polyhedral magnetic fields that confine the energetic injected electrons. Thus, according to embodiments of the invention, a polyhedral overall configuration is utilized which with emphasis on the details of the structure for generating the necessary confining magnetic fields. According to some embodiments, the polyhedral configuration:

(a) uses a substantially spherical magnetic field geometry which is macroscopically and magnetohydrodynamically (MHD) stable for confinement of charged particles to confine a plasma which is slightly non-neutral with excess density of electrons. This requires use of a magnetic field geometry which is everywhere convex towards its confined ion/electron/plasma system. Electrons confined in such a system are allowed to circulate freely from the interior of the device, out through the cusps of the field configuration, and back into the interior again. Electron densities within the interior are maintained at much higher levels than outside by the magnetic trapping of the polyhedral fields. This is essential to prevent the exterior densities from becoming large enough to create conditions for Paschen arc breakdown outside the machine, while keeping interior densities high, to allow the attainment of high interior ion densities. The ratio of electron density inside to that outside is just that of the ratio of trapped electron lifetime inside to that which would obtain had there been no field. This ratio is called the “wiffle-ball factor” and is typically Gwb=1E3 to 1E5.

(b) uses a steady-state magnetic field geometry with minimum losses; e.g., a “mirror” type system without line or ring cusps—its cusps are all point cusps. The geometries of interest utilize special polyhedral configurations for magnetic field generating means. These configurations all have the property that there is always an even number of faces around every vertex of the polyhedron, thus ensuring that alternate faces have opposite magnetic polarities, when the fields are produced by conductors located on or near to the edges of the polyhedron spatial surface. In addition, oscillation of single polyhedral or multiply-faceted interlaced polyhedral surface fields may be useful to provide good magnetic surface “reflection” of confined electrons, by causing the time-averaged fields to appear “quasi-spherical” over the electron gyration time at the local field strength, although such time-varying fields are not essential to the present concept.

(c) uses magnetic field coils whose containing structures are conformal to the shape of the fields they produce, so as to avoid any “corners” or exposed metal surfaces through which field lines can pass directly and thus constitute loss channels for electron loss from the system. Further to space all coil containers at a distance from each other (i.e., so that they do not touch) at the corners of the polyhedral configurations, so that the magnetic fields produced can flow freely between the adjacent coils, without intersecting the surfaces of the coil containers. This spacing is preferably about 3-10 gyro radii in dimension and more preferably about 3-8 gyro radii. Larger gyro radii are not desired to avoid excessive loss of interior trapping of electrons by the main coil system fields, and consequent excessive reduction of Gwb from the levels desired to ensure high interior electron densities. It is generally desirable that no B fields intersect any metal surfaces in the system to avoid electron losses. The conformal structures described herein permit effective shielding of the B fields, and it is generally desirable that most surface be shielded, i.e., optimally less than 1/10,000 of all surfaces are unshielded.

(d) uses the excess electrons thus confined to produce a central electrostatic field which is stable (by virtue of stable electron confinement by the magnetic field) and in which the desired negative potential can be maintained at any density of “trapped” ions (less than the total density of electrons). Ions so trapped will remain within the interior volume until they make fusion reaction collisions, as scattering collisions do not constitute losses, or until successive non-fusion collisions cause energy upscattering to such a degree that ions can leak out over the edge of the electron-driven potential well, and thus escape the system entirely. However, analysis shows that this is highly improbable at densities of interest for fusion power production.

(e) uses injection of electrons at high energies (e.g., 10 kev to more than 400 kev, depending on the ions chosen for confinement) into stable magnetic configurations, to establish negative potential wells of depths sufficient to confine ions at energies at which nuclear fusion reactions will occur. These electrons are injected along cusp axes of the system, from electron emitters which may be biased relative to the polyhedral coils of the device so as to provide the accelerating potential desired, or by stand-alone electron guns, or from metal surface secondary electron emitters also so biased, driven by ion impact from ions escaping out along cusp axes.

(f) uses addition of ions to the system by injection, to attain ion densities needed for useful nuclear fusion reaction rates, and to provide high pressure to support the central plasma core, by dynamic conversion of the kinetic energy of injected ions falling into the confining potential well (e.g., as by two-stream instability coupling of momentum from the in-falling ions to the core field structure, or simply by conversion of ion potential energy at the well edge into kinetic energy at the well center).

According to embodiments of the invention, one may overcome the defects and deficiencies of previous concepts for electrostatic structure for ion confinement to achieve densities of such confined ions at values large enough to allow nuclear fusion reactions to occur at useful rates.

Embodiments provide constraints confinement of ions by utilizing the confinement ability of (MHD stable polyhedral configurations) of magnetic fields for the confinement of electrons, so that stable electric fields produced by their confined distribution in turn may be used to confine the ions.

Other embodiments utilize on the design and construction of the field-generating means, (i.e. the magnetic fields as provided by current-carrying coils in metal containers of the requisite polyhedral face shape) so that all portions of the housings containing the current carrying coils are shielded from the magnetic fields so produced. Thus, all coil containers have cross sections that are shaped to be conformal with the fields these coils produce, and all face coils are to be spaced apart from each adjacent coil, at their “corners” or vertices of the polyhedral configuration, so as to avoid having any metal intersected directly by the fields produced by the coil systems.

It is further the object of this invention to provide a confinement means for ions which can confine a variety of ions of interest for nuclear fusion, at particle energies up to the range of 200-400 kev to 2 Mev, as well as at smaller ion particle energies.

The concepts of the current invention provide for a device able to ensure stable entrapment of positive ions which are injected into negative electric field configurations capable of confining these positive particles. These electric potential configurations are formed by spatially-stable distributions of electrons from electron injection into stable magnetic field configurations, of special dimensional construction, as described above, to yield net excess electron (over ion) density, and thus net negative internal potential distributions.

These stable quasi-spherical magnetic field configurations are all point-cusp mirror fields, placed with alternating sign (or sense) on the surface planes of any of the regular polyhedra when truncated (except for the octahydron untruncated; the octahedron is just a truncated tetrahedron); or on any other arrangement of polygonal faces on or extending from these surface planes, or forming any other ordered polyhedron. A feature of importance to optimal functioning of the current invention is that the arrangement of polygonal faces must be such that all intersection points (between faces) are surrounded by an even number of faces.

Ions may be injected with any energy from (nearly) zero up to (or greater than) that of the energy of injected electrons. Electrons may be injected with energies of 10 kev up to several Mev, but must be injected with sufficient energy to establish central negative electric potential wells of greater depth (strength) than the energy level at which it is desired to promote or contain ion-fusion-collisional interactions among the ions trapped in the negative potential well.

Increasing electron injection energy (voltage) may lead to negative potential well depths great enough to initiate nuclear fusion reactions between injected/confined plasma ions of the light elements and their isotopes (e.g., H, D, T, Li, B, Be, etc.). Increasing injection energy of the ions may likewise lead to such wells, through the mechanism of “virtual electrodes” originally discussed by Hirsch and Farnsworth. Alternatively, some form of both effects may be used in the current invention.

In devices operated at conditions capable of creating nuclear fusion reactions, the strength of the (surface) magnetic fields and (internal) electric potential fields is such that: (a) fusion products will escape entirely from the field regions; (b) unreacted ions will be trapped in the well by the electric fields; and (c) electrons will be trapped internally by the magnetic fields. This is a result of the fact that the radii of gyration of charged particles in the magnetic fields of the device are much larger for fusion products than the dimensions of the device, are comparable for trapped ions at high energy (but ions at the edge, after “climbing” out of the well, will have small gyro radii at their point of return to the in-falling well system, and are much smaller for electrons. This feature is unique among all other concepts for the confinement and generation of nuclear fusion reactions.

One consequence of this feature is that fusion reaction energy carried by fusion product ions is not deposited locally in the entrapped plasma by collisions therewith but, rather, is carried outside and away from the source region in which the reactions themselves are caused to occur. Thus, fusion energy so created does not contribute to the (random or stochastic) “heating” of plasma ions, and the device of the current invention is not an “ignition” machine, nor does its functioning depend upon “heating” a mass of plasma ions to a sufficiently large “temperature” to ensure significant fusion reactions, as is the case for all other magnetic and/or inertial confinement concepts for the attainment of fusion. Certain embodiments thus are power amplifiers, driven by the electrical power input required to make up losses of the energetic injected electrons, with power generation due solely to the fusion reactions created among the trapped ions in the system. The electron flow and losses are—to first order—quite decoupled from the ion flow and fusion generation processes.

Electron and/or ion injection may be steady-state (cw) or pulsed at frequencies from a few Hz to several hundred MHz. This frequency may be made equal to the frequency of oscillation of current flow in the magnetic field coils, if these are driven in an oscillatory mode. Such pulsing of the injection beam which is responsible for establishing the potential well which confines the ions so that they will react among themselves, will naturally cause the inter-ionic reactions to oscillate with the frequency of oscillation of the well induced by the injection pulsation. In such conditions the release of energy from ion nuclear collisional interactions will oscillate as well, and so will the output of (charged) collisional reaction products.

When operated in such a pulsed or oscillatory mode, nuclear-reaction-generated energy may be coupled into oscillations of the confined plasma, itself, to yield amplification of the pulsations and thus to yield high frequency radiative power output, or to yield oscillation of surface potentials on the container walls surrounding the plasma region, and thus to surface (spherical) wave generation. By this means the device can become a self-amplifying, self-powered generator of microwave or other radio-frequency energy. If operated with electron injection currents, ion densities, and magnetic fields which allow large power gain to occur, such a device can be used as a powerful source of radio-frequency energy, for radar, communications, power-beaming, energy beam weapons, etc., with no external source of main power.

However, the basic means of creating fusion is that of steady-state or cw operation, in which electrons are injected continuously, to make up losses, which are predominantly across field lines to the magnetic field-generating coil containers and their minimal supporting structures, and ions are continuously supplied (either from ionization of inflowing neutral gas or from ion injection) to the system to make up for fusion reaction consumption of ions or ion losses from other means. Power produced is thus steady-state, in the form of the fusion products of the reactions between ions in the system.

According to certain embodiments, at the onset of fusion reactions in the device, the fusion product ions will escape from the system, leaving behind their electrons, to yield a still-more-negative confining well. This could lead to a “runaway” effect in which continuing reactions yielding fusion products create an ever-deepening well, which in turn increases the fusion rate, which deepens the well more, etc. This process will be stopped by burnout of the ion fuel in the well, by arcing or other “shorting” or destabilizing effects, or by reaching stable burn conditions in balance with the ion and electron injection rate, and the rate of escape of electrons and of ions from the surface of the confinement region (i.e., from the magnetic field). The nature of this self-initiated creation of deeper potential wells will depend upon the species of ions used in the device, and undergoing fusion reactions. If all the ions involved carry only single nuclear charges (i.e., if all have only one proton in the nucleus), then the onset of fusion reactions can lead to a well-deepening effect, as described above, only for a limiting transient period. This transient will be damped out by the continuous injection of new electrons and ions, to reach a new stable density distribution. However, if the ions involved carry more than one proton in their nucleus and are injected only partially stripped, with a single charge, then the onset of fusion will trigger an exponential well-deepening process stabilizing at a new, deeper well depth as a result of each fusion reaction leaving more electrons behind in the well than were originally injected.

According embodiments of the invention, particle injection (ion or electron) may be along the magnetic cusp field axes, or offset but parallel to them, or in an annular sheath around these axes. If annular, the particle sheath may be injected with or without rotation; if offset-axial or on-axis the particle beam may be injected with or without rotational or nutational motions. If rotation/nutation is used in the injection process, this will have the effect of preventing the particles from “falling” directly radially inward into the potential well, towards zero radius. Rather, such particles will be constrained to converge to a minimum radius greater than zero on account of the angular momentum they possess by virtue of the rotational momentum with which they were injected. Of course, in any realistic source of electrons (and of ions) there will always be a transverse component of energy, transverse to the radial motion due to the well gradient, that will prevent some of the particles from reaching the exact center of the potential well. Thus there will always exist a central “core” whose size (rc) will depend on the ratio of transverse energy at the edge of the well (dEtrans) to the well depth (Ewell), such that the fractional core size will be approximately <rc>=(rc/R)=(dEtrans/Ewell)^{1/2}.

The beneficial effect of such angular momentum on stabilization of the confining potential well has been shown by experiment. J. T. Verdeyen, et al, “Recent Developments in Electrostatic Confinement-Experimental”, Ann. of the N.Y. Acad. of Sci., Vol. 251, May 8, 1975. In these experiments it was also shown that the introduction of angular momentum results in formation of a “virtual” central electrode of small radius (rc, as above), and in the reduction of well depth at the center, over the rc region and beyond to ca. 2-3×rc, with maintenance of the general shape of the remainder of the potential well distribution (this is usually found to be relatively flat, at maximum depth, out to a short distance in from the edge, where the potential rise quite sharply on scales of the gyro radius of electrons and of the Debye length at the injection edge. Ions may be formed in the surface regions by ionization of inflowing neutral gas atoms, by collisions with recirculating fast electrons, or may be injected in parallel with electrons (annular and axial beams) or opposing the electrons (opposite magnetic cusp faces on the polyhedral configuration (used), or in opposing each other, or in parallel with ions, or in any other fashion recognized to be appropriate by one of ordinary skill in the art.

Fusion reaction products will generally escape regions containing the plasma, electrostatic fields, and electrons, and be deposited in and on structures around but outside of these regions. Since these products are all positively charged and carry high energy (several Mev each) their energy may be converted directly to electrical energy in external circuits by causing the external structures (on which the fusion products impinge) to operate at high positive electric potentials (voltages). With such an arrangement the positively-charged fusion products must escape “up hill” against the applied positive potentials, and can drive electrical energy into any circuit to which the external structures are connected and which closes back to the plasma/electron/well region.

The pressure of particles in the well will be supported by the external magnetic field which confines the electrons, through the inertial effects of conversion of the kinetic energy of in-falling ions to electrostatic dynamic pressure on ions confined in (but moving outward from) the central core of the potential well reacting volume. This well itself is produced by the conversion of the inertial energy of injected electrons to the energy of the well depth at the electrostatic potentials established by the stably-confined electron density. This electrostatic well gives energy to the in-falling ions, which in turn couple their thus-acquired energy of motion (and momentum) into confinement pressure on the core. The kinetic energy of injected electrons thus, through the medium of the electrostatic well, is transformed into the kinetic energy of in-falling ions.

The ratio of momenta of ions and electrons of the same energy is given by the square root of the ratio of their masses, thus this transformation has the effect of producing an ionic “gas” whose (dynamic) pressure is very much larger than the equivalent (dynamic) pressure of the injected electrons. In addition, the convergence of the quasi-spherical geometry of the polyhedral configurations of interest increases the local dynamic pressure by the square of the inverse ratio of radii from the outer (electron injection) radius to the inner (ion dynamic pressure confinement) radius, rc.

As an example of these effects, if the ions are those of deuterium (D=²H) and the radius of the inner core is 0.1 that of the inner “surface” of the confinement field region, then the ratio of ion-generated pressure on the core to electron pressure on the (external) confining field will be roughly 6100:1. The physics phenomena invoked in this invention thus have the effect of creating an electrical “gas” inside the magnetic field region whose (dynamic) pressure at large radii is very much less than its “pressure” at small radii within the volume which it occupies.

For this reason, it is possible to contain and confine a high density of reactive ions in a small radius within a larger radius at which a relatively weak magnetic field is placed; it is not necessary for the magnetic field to provide the confining pressure over a large radius to hold the high density plasma together at the pressure at which it operates within the smaller radius core. For example, ion densities of 1.0E15 to 1.0E17 per cm³ may be sustained in D at 100 kev with surface magnetic fields of only 3 to 10 kG (kilogauss).

Note that scattering collisions in this geometry do not directly increase particle losses, because they occur near the center and their effect of changing the direction of motion still leaves all motion predominantly radial in vector direction.

It is important to note that requirements on ion beam injection power are minimal in an electron-injection-driven device, since most of the ion energy is acquired by “falling” down into the negative electric potential well set up by the electron injection. This potential well depth is established by the net excess electron density which is set up over the ion density contained therein.

This is limited by the loss rate of electrons from the surface region of the polyhedral magnetic field configuration. Higher fields give smaller loss rates; larger injection currents allow larger losses. Thus, the balance between losses and input will set the level of excess electron density. Numerical calculations show that only modest electron injection powers are required with modest fields (as above) to yield very deep electrostatic wells for ion confinement (e.g., over 200 kev), provided that electron losses are limited only by their cross-field transport to the containing surfaces of the magnetic field generating means. Thus it is important that the containing surfaces of the magnetic-field-generating coils not have any surfaces that are not conformal to the spatial shape of the fields produced by the coils, and thus must be smooth and field-conforming at all points.

For example, a typical coil system for a truncated-cube polyhedral configuration as, for example, shown in FIG. 8, would be a set of six coils, square in plan form, of circular cross-section, with conductors within the circular containers, each laid slightly offset from the edges of the polyhedron, so that their corners (i.e., edges of the polyhedral) do not touch, but are spaced at (e.g.) 5 electron gyro radii from each other. The coils are held together by metal connecting tubes connecting each coil to its adjacent coils at the corners of the polyhedral, with the connecting tubes located well outside the mid-plane of the coil systems, so as to be in regions of electron density which are lower density than those in the interior of the machine, thus reducing electron losses to these relatively unshielded metal surfaces. Some degree of shielding can be provided if the conductors within the coils also connect from coil to coil by conductors running through the connecting tubes. In this case, the connecting tubes would provide stability of the coil structures by joining them mechanically together and would provide a conduit for electrically connecting each coil to the power source since all coils would be connected together in series.

According to another feature of the invention, embodiments may utilize a finite coil in which connected coils are replaced with coils with gaps between them. Preferably, the coils are placed on the outboard side of the confining coils. As described below, this feature dramatically increases electron confinement. The power output is set by the rate of reaction within the central region, integrated over the volume of this region. The reaction rate is determined by the square of the ion density (and the product of reaction cross-section and particle speed), thus is limited by the ion current density in the central region. In-falling ions will converge as the inverse square of the radius, thus the reaction rate will tend to vary as the inverse fourth power of the radius. This very rapid dependence ensures that nearly all of the fusion energy generated in such a device will be generated in and around the center of the (structurally-empty) cavity confined by the external magnetic field, at the largest possible distance from the walls of the system. It will be somewhat like a little “star” burning in the center of the electrostatic well cavity “void”.

Numerical calculations show that the ion current densities required for total fusion power output at “useful” levels for certain applications is much larger than those required for power balance makeup against electron losses. To achieve this state requires a current multiplication or “gain” (Gⱼ) achieved by the recirculation of ion (and electron) currents across the machine volume many times, until a sufficient ion density is achieved. The required current recirculation factor is found to vary roughly as the inverse fifth power of the major radius R of the device, so that Gⱼ.≈(1/R⁵). Large devices thus will require less current “gain” than small devices, and it is clear that there must exist a size sufficiently large that the “gain” may be unity (Gⱼ=1), and that no current multiplication is required for operation of the machine at a breakeven power balance. Numerical calculations show that this size is approximately R.≈10-20 m, and that Gⱼ.≈1.0E6 will allow R.≈20-30 cm (Gⱼ values greater than 1.0E6 have been obtained in a variety of electron and ion magnetron tubes of other types).

Sizes of interest are, of course, smaller than the larger of the two above, and larger than the smaller of the two above. Limitations imposed by requirements of heat removal at reasonable heat flux rates show that a size range of R=1.5-3 m is preferred; for this range Gj factors of the order of 1E3 are required. This is relatively easy to attain for the ion flow. Concurrently, electron recirculation factors of approximately the same order 1E3, are sufficient to yield interior densities large enough to support high ion densities and large fusion power, while still maintaining exterior densities low enough to prevent Paschen arcing in the exterior regions. Of course, vigorous vacuum pumping must be supplied to the exterior regions to sustain the lower densities required for this purpose; typically exterior densities in the range of 1E10-1E1/cm³ are required.

Electron losses are governed, not by Gwb, but—in part—by the rate at which electrons are able to cross the polyhedral magnetic fields to reach the field coil containers and to reach the small connecting tubes or structures that hold the coil containers in place, 1 mg. Extensive experimentation has shown that the loss rate of electrons across the field lines is given by an equation for the cross-field electron transfer current (Magnetic Grid or MaGrid) which is Img=Kj(A)(E)((n)^{1/2})/(B̂(¾)). Here A is the surface area of the coil containers, E is the electron injection energy, n is the maximum density of electron just inside the coils (sometimes called the “edge” density)., and B is the maximum strength of the magnetic field on-axis. The coefficient Kj has been found by experiment to be in the range of 2-4E-12, for A in cm², E in eV, n in 1/cm³, and B in G, with 1 mg in amps. The numerical value of electron current required is just Img(ks)=Img(2πE18); here ks is just the number of charges/sec for one Coulomb/sec or for one amp if current.

In addition to the cross-field losses, 1 mg, losses must be accounted for to the other structures (i.e. the connector tubes or structures), Ist, of the coil system. This adds another term to the equation for total electron current drive required, to be Ie=Img+Ist. The structure losses can be estimated as losses to structure area, Ast, from the cross-field formula above, but using Bst as the local B field around the connecting tubes, and nst as the local density halfway between the interior and exterior densities in the system. The local B field is determined simply by the formula for magnetic field around a conductor, Bst=0.2Ist/rst, where rst is the radius of the connectors. The area of these is Ast=12(2π)(rst)(s), where s is the spacing between coils at the corners, and the local density is just nst=n/((Gwb)^{1/2}). Taken together, these factors may typically double the drive current required in practical devices, thus Ist=2Img is typical of good design of these machines.

From this equation, it is possible to determine the net trapping factor, Gmj, for electrons, against losses, in the device considered herein. This is not to be confused with the wiffle-ball factor Gwb, which only gives the interior/exterior density ratio of the machine. This is just Gmj=(nv/4)(A)/Ie(ks), where v is the velocity of electrons at injection energy, v=1E8((E)^{1/2}) cm/sec. Now, the optimal condition for operation is when the electron injection has produced an electron density in the machine which is the highest possible density, as limited by the ability of the magnetic field to contain the interior electron “gas” pressure. This is obtained when the internal kinetic energy density of the electrons at the system edge is exactly equal to the magnetic field pressure or energy density at this same edge, or when nE(ke)=(B̂2)/(8π). Here ke is just a conversion factor, ke=1.6E-12 ergs/ev for E in ev, B in G, and n as before. With this to replace n in the previous formulae, the net electron recirculation/trapping factor becomes

Gmj=(3.2E−7/Kj)(B^{7/4})/(E). As an example, consider a system with E=1E5 ev, B=1E4 G, and take kJ as 3.2E-12; then Gmj=1E7. Of course, losses to even the most minute unshielded metal areas in the system will reduce this drastically, and it can be expected that practical values of Gmj may be less than this by factors of 100 or more. This also illustrates the necessity of reducing unshielded surfaces (i.e. surfaces into which magnetic fields pass directly, and thus which offer direct loss channels for electron flow) to as small an amount as possible.

Another feature of the device is the existence of a “black hole effect” (BHE) in respect to fusion burn reactions. This results from the fact that there must exist a radius at which the fusion reaction collision rate is sufficiently large that the total fusion reactions occurring per unit volume over the time of flight of an ion from this radius to the center of the machine would equal or exceed the total density of ions at this radius. For such a condition it is clear that all ions entering (i.e., falling into) this radius region will undergo fusion reactions. However, it appears that these conditions may be very difficult to achieve in practice.

### BRIEF DESCRIPTION OF THE DRAWINGS

These and other aspects of the invention will become more clearly understood from the following description read together with the drawings, in which:

FIGS. 1A and 1B are diagrams showing the magnetic force lines for a conventional simple bi-conic magnetic mirror plasma confinement device as described above;

FIG. 1C is a diagram illustrating reflection of a moving charged particle at a point cusp, described above;

FIG. 2 is a diagram of a known polyhedral devices for confining plasma, described above;

FIG. 3 is a diagram showing a known arrangement for electrostatic confinement of electrons, described above;

FIG. 4 is a diagram showing direction of current flow in an octahedral magnetic field generating and electron confining device according to the present invention;

FIG. 5 is a partially schematic perspective of a single turn of a magnetic coil for face 410 of the octahedral magnetic field generating device depicted in FIG. 4;

FIG. 6 is a partially cutaway and schematic view of a potential well and particle concentrations in an octahedral device according to the present invention;

FIG. 7A is a cross-sectional graph and FIG. 7B a plan view of the potential well and ion concentrations in the present invention;

FIG. 8 is a diagram showing a current flow pattern in a truncated cube configuration of an ion confinement device according to the present invention;

FIGS. 9A and 9B show a side and perspective view respectively of a truncated cube system set of coils, using coils of circular plan form, with B field conforming containers of circular cross-section, space apart at their “touching” corners (i.e., the vertices of the polyhedron), to avoid B field intersections with the container metal surfaces;

FIG. 9C shows a cross sectional view of one of the coils taken along line 9C-9C in FIG. 9A;

FIG. 9D-F shows the effect of coil placement according to an embodiment of the invention on magnetic field strength and confinement.

FIG. 10A shows a side view similar to that of FIG. 9A, but includes the external screen, vacuum vessel and external equipment used in the system;

FIG. 10B shows a perspective view of the device of FIG. 10A with the external screen which provides a controllable potential boundary for the entire system;

FIG. 11 shows perspective view of a truncated cube polyhedral system formed from square plan form coils, each conforming to the requirements of B field conformance and inter-coil corner spacing;

FIG. 12 is a diagram showing one possible arrangement for ion and electron injection into a truncated cube embodiment of the present invention; and

FIG. 13A is a diagram showing a cross-sectional view of the embodiment of FIG. 12 taken along X-X and arranged as it might be arranged to serve as a heat-generating and thermal/electrical conversion element of a power plant, and FIG. 13B shows a direct-electrical conversion element.

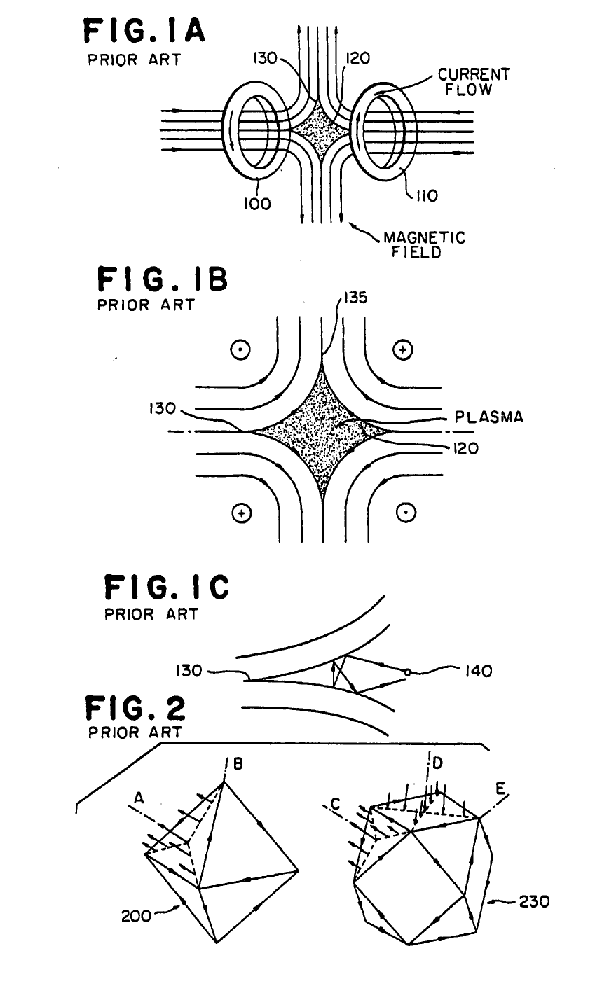

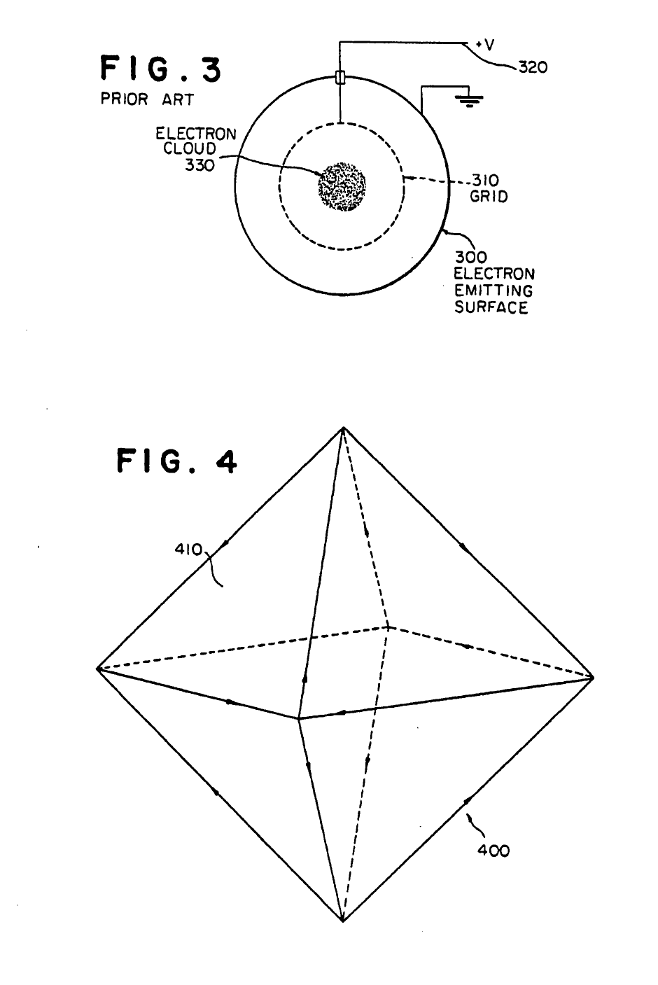

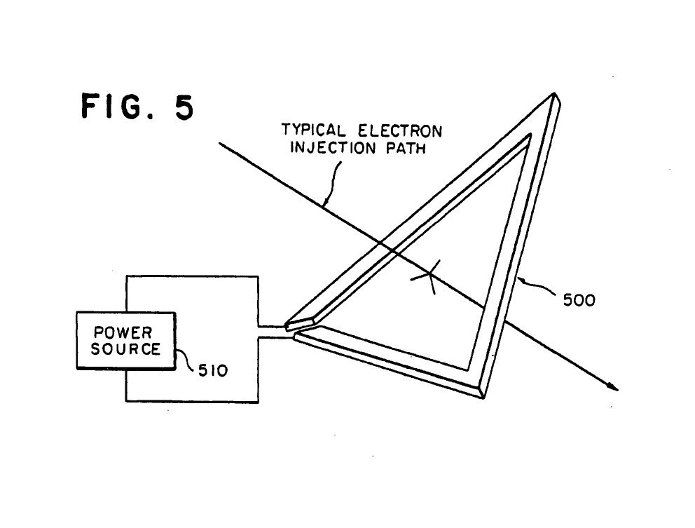

### DETAILED DESCRIPTION OF THE PREFERRED EMBODIMENTS

Embodiments of the invention achieve large ion densities in stably-confined plasmas, held in negative electric potential wells formed by magnetically-confined electrons. Electrons are injected along the field lines surrounding and entering the central (confined-plasma) volume. Injection is through point/polar magnetic cusps in an inherently confinement-stable magnetic mirror field system with minimum loss properties. Such systems are attained in embodiments of the present invention by use of various polyhedral magnetic cusp confinement geometries using tetrahedral, octahedral, and/or dodecahedral configurations, or any other polyhedral system which has an even number of faces surrounding every vertex point. Unlike the bi-conic mirror systems, such configurations have the property that coil windings may be made along the edges of their faces in such a way that no ring or line cusps are generated in the magnetic field geometry, all magnetic loss cones are through point or “polar” cusps, only.

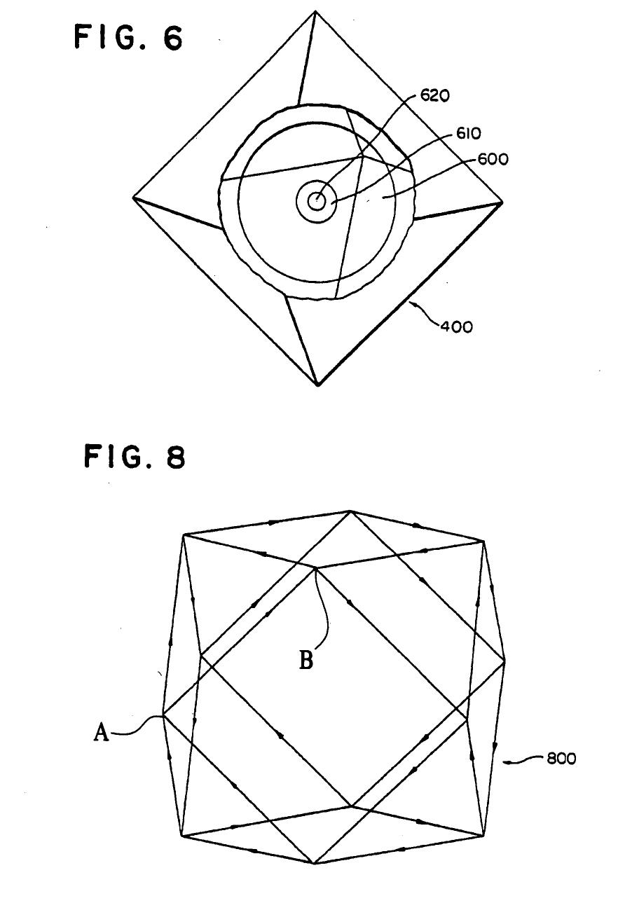

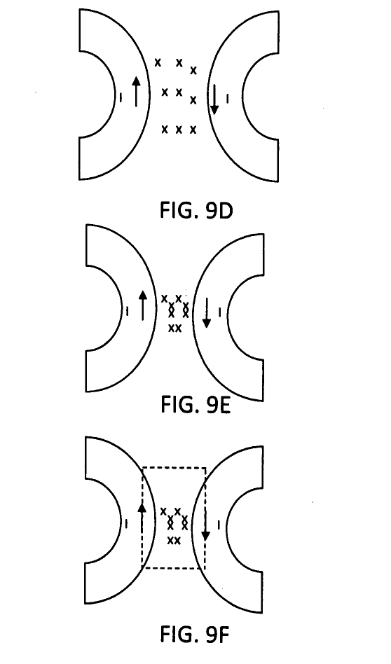

The geometries preferred for this system are all of the regular polyhedra truncated on each point, except the octahedron, which may be used without truncation (it is already the truncation of the tetrahedron). Any other polyhedron in which all the magnetic vertices are surrounded by an even number of polyhedron faces may be used as well. For such figures the magnetic field point cusps (or “magnetic poles”) are to be centered on each face of the polyhedron, in an alternating pattern, so that no two adjacent faces contain cusps of like sign. The criterion for this is simply that all vertices be surrounded by an even number of polyhedron faces. FIG. 4 shows possible current paths for such a cusp field arrangement for the octahedron, and FIG. 8 shows this for the truncated cube. It should be noted that opposing faces of such polyhedra all lead to bi-conic mirror fields of opposing sign, except for the truncated tetrahedron (the octahedron), in which the opposing fields are of like sign. The octahedron thus is equivalent to a four-fold intersection of mirror-cusp-ended solenoidal fields, in which each mirror cusp provides stabilization for its adjoining solenoidal field regions. The overall geometry of the relevant magnetic field will be referred to herein as “substantially spherical” or “quasi-spherical.”

Attention will now be focused on an octahedral system, starting with FIG. 4. As mentioned, the octahedron 400 depicted therein has current flowing along its edges to establish a magnetic field exhibiting point cusps on each face 410. The signs of the point cusps alternate between adjacent faces. One possible current flow pattern is depicted by the solid arrowheads shown in the drawing. The current paths are shown as directly on the polyhedron edges, whereas a realistic system must have these separated at the corners, and be slightly offset from the edges in consequence.

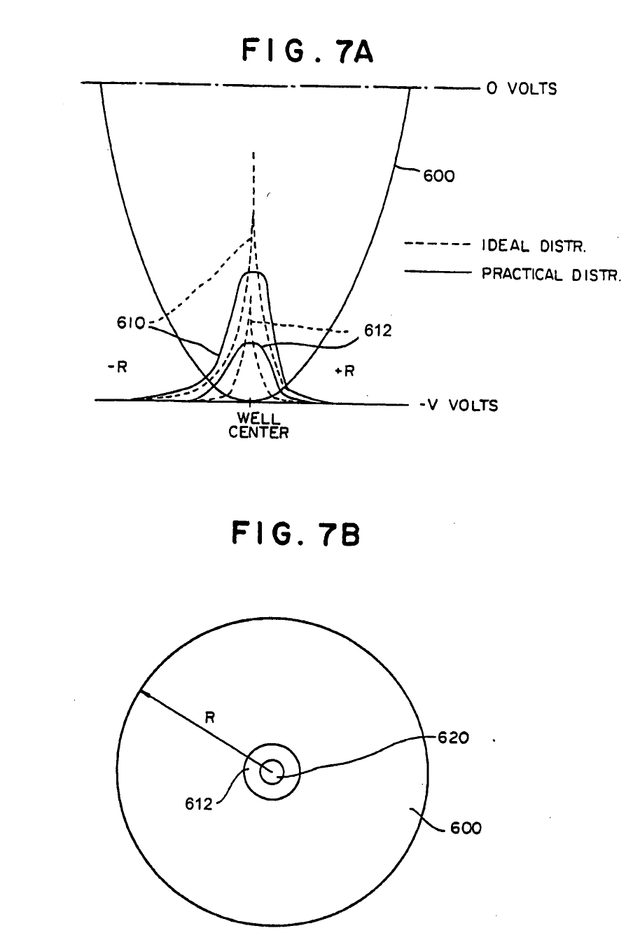

FIG. 5 shows one of the current carrying elements 500 used to generate the magnetic field. Current carrying element 500 is supplied with current from a power source 510. This power source 510 could be an a.c. or d.c. power source.

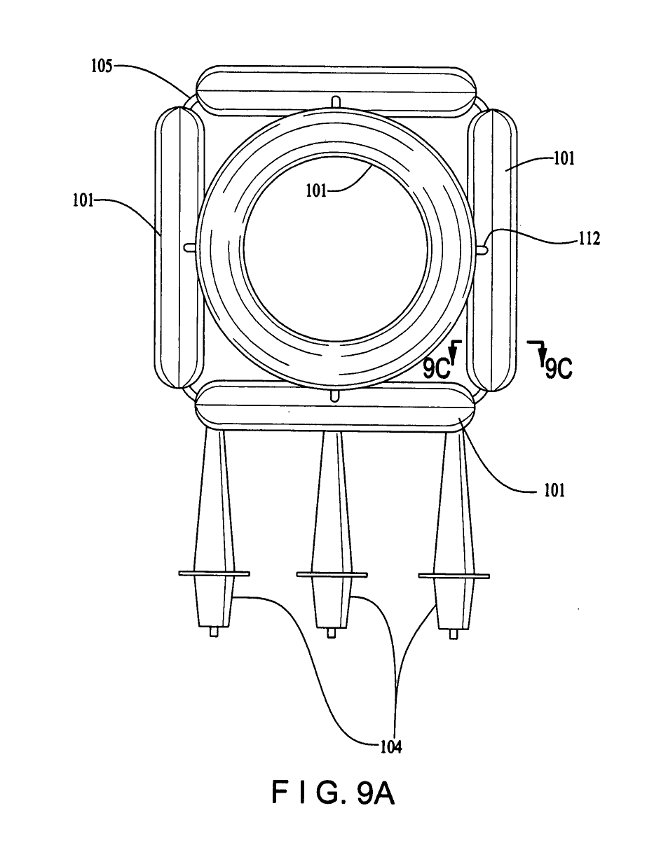

FIG. 6 illustrates electric field and particle density distributions during operation of octahedral magnetic field generating or plasma confinement device 400. Details concerning the generation and configuration of the magnetic field are omitted for clarity. The electron and ion injectors used respectively to establish the negative well and “spill” ions into the well will be set forth in greater detail below in connection with the truncated cube system.

As depicted in FIG. 6, electrons injected into the octahedral magnetic field source become trapped by the magnetic field to form a substantially spherical negative potential well 600. The probability of locating an electron increases toward the center of the negative potential well. Electrons are originally injected to establish the negative potential well 600 and then continuously injected thereafter to sustain the negative potential well 600. Synonyms for negative potential well would include virtual cathode or negative space charge.

Once the negative potential well 600 is established, positive ions are injected into it at relatively low energies. The positive ions “fall” into the well, then increase in kinetic energy as they are drawn toward the center. The charged particles oscillate across the potential well. As the ions cross the center, they encounter and interact with other ions. It is anticipated that attainable plasma temperatures and confinement times will meet or exceed the thresholds required for useful levels of fusion reactions, in which fusion power generation is significant. This is depicted in FIG. 6 as a central region of maximum collision density 620. This collision density varies ideally as the inverse fourth power of the radius, and so is highly peaked at the center of the spherical well, although practical considerations (finite, non-zero transverse momentum at the system edge) prevent it from reaching near-infinite density as r approaches zero.

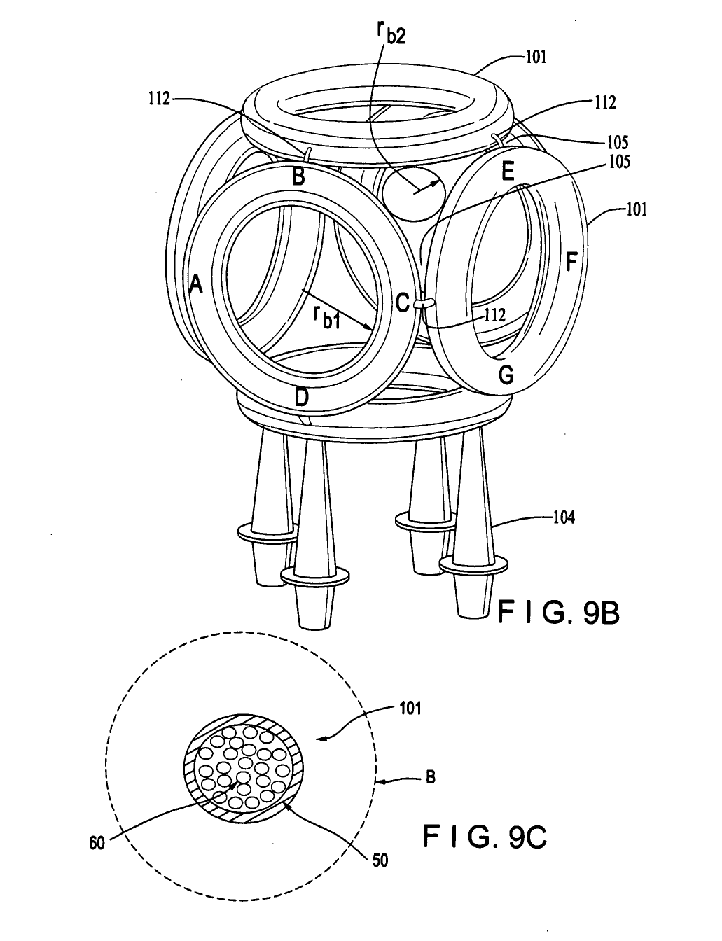

The negative potential well 600 is also depicted graphically in FIGS. 7A and 7B. The diameter of the well is designated 2R. The “depth”-V corresponds to the voltage used to accelerate the electrons for injection into the cavity. Qualitative density distributions are also depicted for the “ideal” case and the “practical” case. Curve 610 corresponds to higher drive voltage than curve 612.

Alternatively, ions may be injected to form a positive “virtual (anode) electrode” in the device center as described by Farnsworth and Hirsch, with electron injection in addition towards and through this virtual electrode, to form an ion-confining negative potential well within the ion-formed virtual anode. In either case ions will be trapped by negative potential wells which are, in finality, held in place stably by circulating electron currents tied to stable external magnetic fields of an appropriate polyhedral geometry which ensures low electron losses and ease of injection of electrons and ions into the system.

FIG. 8 depicts a truncated cube system 800. A possible pattern for current paths along the edges is shown using small solid arrowheads. In accordance with embodiments of the invention, the current paths are positioned displaced from (i.e. spaced apart from) the edges shown in FIG. 8 so that the coils do not touch (i.e. are spaced apart) at their corners (i.e., representative points A, B in FIG. 8) as explained further herein. For this purpose, the coils are positioned slightly within the edges shown in FIG. 8 and toward the center of each face. Further, it is pointed out that there are no separate coils for the smaller triangular faces since the edges of the adjacent larger square faces also define the associated smaller, triangular faces. Another point to note is that the current direction for all of the coils is the same direction (clockwise) so that the magnetic field is everywhere convex for the ions/electron plasma.

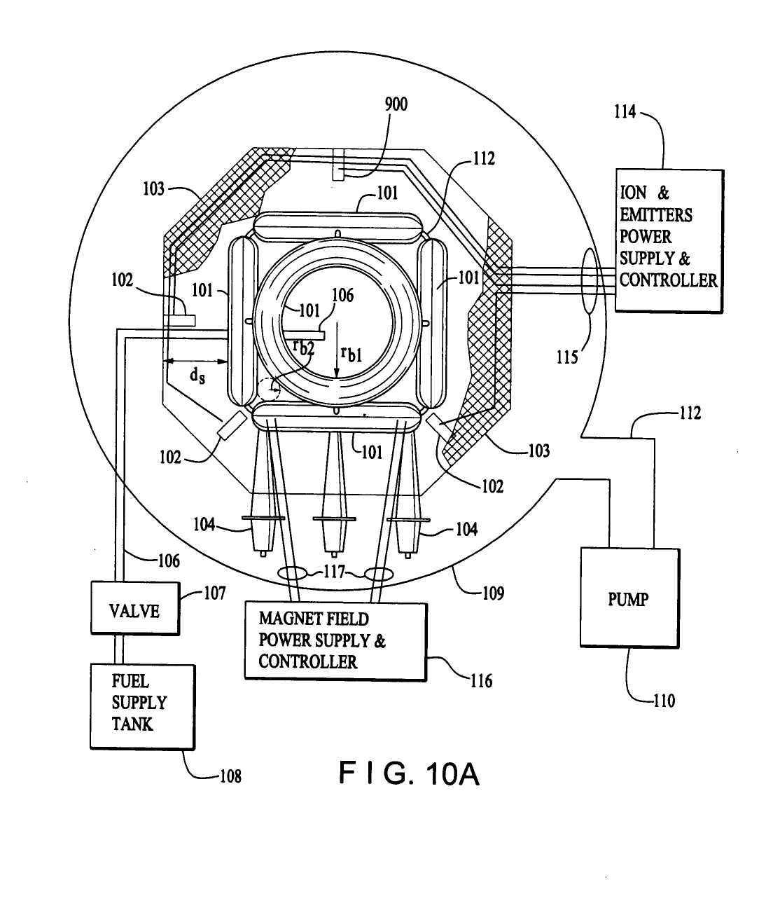

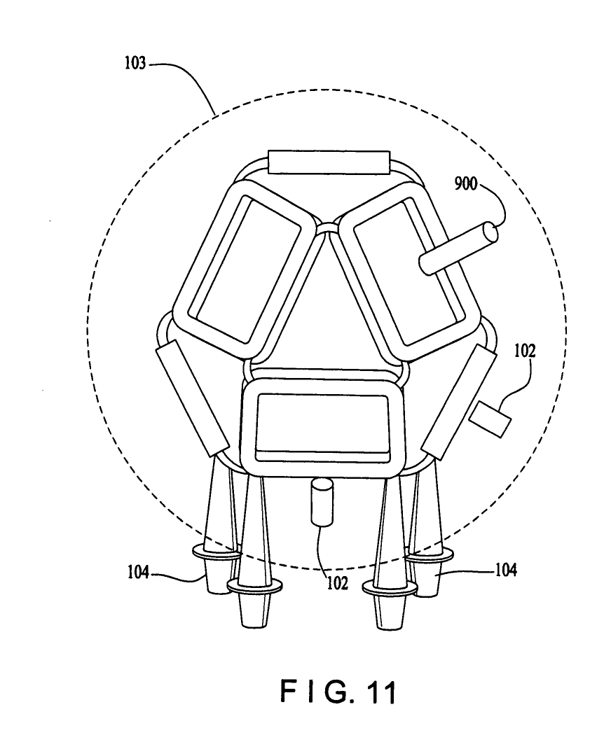

Further, the coil conductor assemblies are made so that the coil containers are always conformal to the shape of the magnetic fields produced by the conductors within, except at portions that connect the containers together. Thus—typically—all coil containers must be approximately circular in cross-section, whether they be circular in plan form or square, or polygonal in plan form. That is, regardless of the plan form shape of the coils (circular as shown in FIG. 9B or square as shown in FIG. 11), the cross sectional shape of the container housing the coils is substantially circular since the B filed produced by the current carrying coil has a circular contour which lies in a plane perpendicular to the current direction within the coil. The use of this conformal shaped coil housing or container greatly aids in preventing electron losses by collisions with the coils.

FIGS. 9A, 9B and 9C show an example of a system which uses circular coil structures 101 in a truncated cubical array. Note the spacing 105 between coils, and their conformal circular cross sections (FIG. 9C). Points A-G have been shown in FIG. 9B. Points A, B, C, and D are within one of the large square faces of the truncated cube (see FIG. 8), and points C, E, F, and G are within an adjacent large square face. Points B, C and E are within the smaller triangular face adjacent the above defined larger faces. (See the triangular faces of FIG. 8). Also shown in FIG. 9B are the radii rb1 for the large face hole and rb2 for the smaller triangular face hole defining the larger and smaller cusps face holes respectively.

FIGS. 9A and 9B also show connecting tubes or structures 112 used to join the coil structures together to provide structural rigidity. In an embodiment, these connecting tubes 112 may carry the coil conductors from one coil structure to an adjacent coil structure so that all coils of the coil structures are essentially connected in series. Such an arrangement permits a minimally invasive way to provide power to each coil structure 101 since otherwise, power to each coil structure 101 would need to be delivered through separate structures from outside the vacuum as for example via insulated supports 104. When the connecting tubes 112 electrically connect the individual coil structures 101 together, the insulated supports 104 need only directly connected to one coil of one coil structure 101, as all remaining coils will be powered by the one connected coil through the series connection enabled by the connecting tubes 112.

FIG. 9C shows a cross section of the coil structure 101, which is seen to contain a housing 50 surrounding a current carrying conductors (coil) 60 which may generally be implemented by a conductor having a plurality of turns. For large machines, the conductor (coil) 60 may contain a central channel for water cooling and may also be implemented by a plural layer construction in which a water cooled copper conductor is surrounded by an insulator (such as rubber, Teflon or the like) which is in turn surrounded by a conductor (such as aluminum) to protect the insulator. The conductors or coils 60 may also be implemented using superconductor wires. Significantly, the cross sectional shape of the housing 50 is seen to be conformal to the B field surrounding the coil. The shape of the B field is shown in dotted line in FIG. 9C.

FIGS. 9A and 9B illustrate a the finite coil embodiment of the present patent. Note that in FIGS. 9A and B that the connected coils embodied by FIG. 8 have been replaced by coils with gaps between them. Also note that the connectors between the coils are placed on the outboard side of the confining coils. FIG. 9C shows conformal flux surfaces for an individual coil.

FIGS. 9D-F show the effect of coil placement according to the embodiment of FIGS. 9A-C. This configuration dramatically improves the confinement over the previous Polywell configuration, such as described in U.S. Pat. No. 4,826,646. Specifically, if two coils (see FIG. 9D) containing oppositely flowing currents are placed are placed near one another, they produce a strong magnetic field (illustrated by the density of the x's) between them. The closer those coils are spaced, the more intense the magnetic field becomes (see FIG. 9E). The region of the Polywell where the coils are closest to each other have the most intense magnetic field in the entire Polywell system, and thus show the strongest electron mirroring effects and the best confinement. However, if those coils are joined together (illustrated by the dashed box in the FIG. 9F) then these intense magnetic fields run directly into the conductor and lead to large electron losses. These field lines in this region reach farther into the confined plasma than any others, so these losses are considerable. This is the major problem with the device described in the prior Polywell system according to U.S. Pat. No. 4,826,646

The illustrated embodiment replaces the region of bad confinement with a region that confines better (i.e. has larger magnetic field) than any other part of the device. Furthermore, the connectors between the coils are placed as far away from the central plasma as possible so they receive the maximum shielding effect of the electron mirroring from the strong magnetic field. Such embodiment of the invention shows an order of magnitude improvement in the electron confinement. See Robert W. Bussard, “The Advent of Clean Nuclear Fusion Superperformance Space Power and Propulsion”, 57^{th} Int'l Astronautical Congress (IAC 2006), the contents of which is hereby incorporated by reference in its entirety.

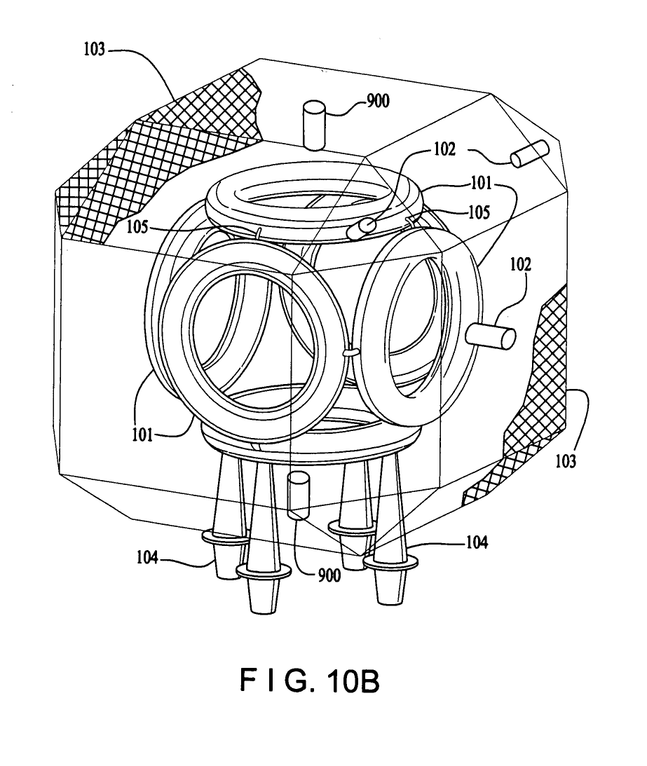

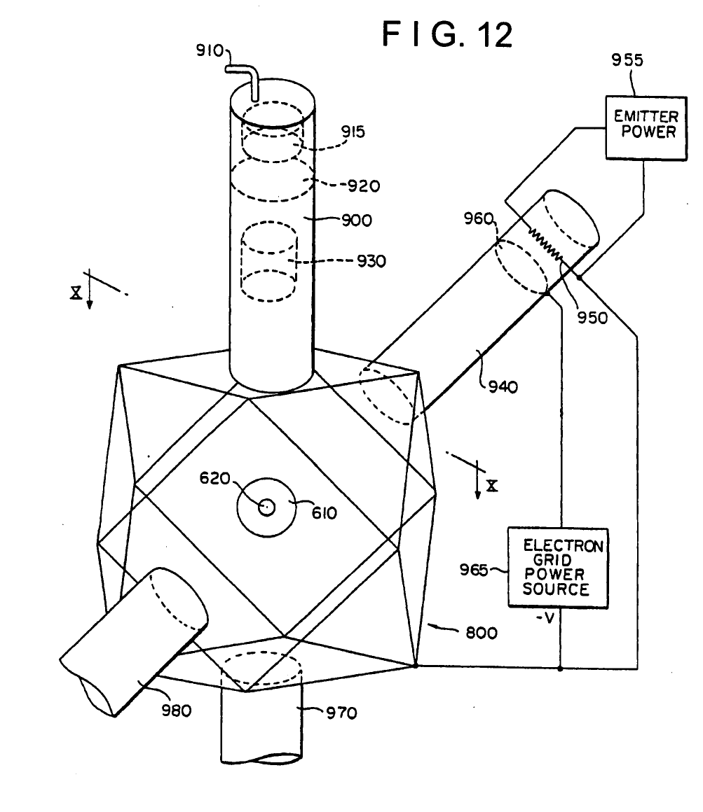

FIGS. 10A and 10B show the system of FIGS. 9A and 9B mounted within an external shell or screen 103, supported on insulated supports 104 through which power is supplied to the machine to keep it at high positive potential and through which current is supplied to the field coils of the coil structures 101. Positive ion injectors 900 (see also FIG. 12) are arranged on one or more of the cusps axes of the truncated cube structure. Electron may be generated by active electron emitters or by repeller plates generating secondary electrons by means of ion bombardment or by a combination of both and either or both sources of electrons are included with the term emitter/repeller plates. Emitter/repeller plates 102 are provided on others of the cusp axes of the system and are held at ground potential. The spacing of the screen 103 from the coil structures 101, shown as ds. Although not shown to scale in FIG. 10A, it is generally desirable that the distance ds be greater than the radius rb1, and typically ds is in the range of (2-3)×rb1. The emitter/repeller plates 102 are placed at a distance from the coil structures not less than rb1 for the larger, square face or rb2 for the smaller, triangular face to avoid reduction of the edge potential on these faces. However, the emitter/repeller plates 102 must not be placed too far from the coil structures else their emissive action will be reduced due to excessive distance from the attractive potential of the coils themselves. Typically the emitter/repeller plates 102 are positioned from their face holes on axis at a distance (1-1.5)×rb1 for the larger, square faces and (1-1.5)×rb2 for the smaller, triangular faces.

FIG. 10A is a representation of the truncated cube polyhedral system showing the arrangement of fuel gas supply lines 106 required to supply fusion fuel to the machine interior, from a fuel supply tank 108 located outside the entire system. The actual supply flow is controlled by a valve 107, which is controlled so as to deliver the amount of fuel needed to make up for fuel consumption due to both losses and fusion burn-up in system operation. Also shown is the entire system mounted within a vacuum tank or vessel 109 to allow vacuum pumping to avoid Paschen arcing in the regions external to the machine. A pumping device which may be composed of a series of pumps is provide and represented at 110. The pumping device 110 evacuates the vacuum tank 109 via line 112. Power to the emitter/ repeller plates 102 and to the positive ion injectors 900 is provide by ion & emitter power supply source and controller 114, over lines 115, and power to the coil structures 101 producing the magnetic fields is provide by magnetic field power supply and controller 116 over lines 117. For simplicity of illustration, only a sampling of the emitter/repeller plates 102 and ion injectors are shown connected to the ion & emitter power supply and controller 114.

Power to the coils of the coil structures 101 may be fed through the insulation supports, and likewise only a sampling of the coils are shown connected to the magnetic field power supply and controller 116.

In other embodiments, the ion injectors 900 may not be needed as ions may be produced by ionization of the neutral gas injected into to central region of the polyhedron via the fuel gas supply line 106. In still other embodiments, the ion injector 900 may be used together with ions produced by electron bombardment of the neutral gas.

FIG. 11 shows a truncated cube polyhedral system using square (plan form) coil structures 101′, in the same system configurations as shown in FIGS. 9A, 9B and 10A, 10B In this arrangement, the main face (larger, square face) square coil structures may be offset slightly, to smaller positional placement, from the spatial polyhedral edges, so that their structural containers do not touch where the coils meet at the corners (vertices) of the polyhedron. It is noted that these same coils that lie on the square faces of the polyhedron also provide the current paths defining the smaller, triangular faces (when one considers together three squares surrounding each triangle), and no separate coils for the smaller triangular are needed or desired. Thus, even thought one may speak of square shaped (plan view) coils for the main faces and triangular shaped (again, plan view) coils for the triangular faces, it is understood that these are one and the same coils.

It is noted that the cross section of the coils 101′ has the same shape as shown in FIG. 9C. That is, even though the plan contour of the embodiment of FIG. 11 shows the coils 101′ having a square shape, the cross section at any point (perpendicular to the current flow direction) will look exactly like FIG. 9C since it is important to have the shape of the container for the coils (coils 101′) conform to the shape of the B field produced by the coils 101′. Moreover, it is likewise important that the coils 101′ be offset from the edges positions shown in FIG. 8 slightly toward the center of each face so that the coils 101′ do not touch at the corners (points A, B, for example of FIG. 8) of the truncated square.

The truncated cubic array system may be operated in steady state or pulsed mode depending on the available cooling and power supply systems utilized. When operated in pulsed mode at well depths of 10 kev, the system produced fusion from DD reactions at a rate of 1E9 fusions/sec, about 100,000 times greater than the best previous work at similar conditions, done by Farnsworth and Hirsch in the late 1960s.

FIG. 12 provides details of electron and ion injection. In the polyhedral systems of interest here electrons may be injected either directly along a cusp axis (or axes) or in an annulus around such axis/axes. If injected in an annulus, they may be injected either with paraxial velocity (along the local cusp field lines) or with a rotational component around the cusp central axis. A negative potential well is thus formed by the injected electrons converging to and trapped within the central region of the externally-driven magnetic field system. Ions are injected to be trapped in this negative potential well. These may be injected coaxially with the electrons, in an annulus surrounding the electron beam, with or without ion beam rotation, or in a central axial beam within an annular electron injection beam, or may be injected through magnetic point cusps on faces of the polyhedral system opposing the electron injectors. Ions may also be produced within the interior boundary of the system by ionization of neutral fuel gas supplied externally as in FIG. 10A, by collision with the dense energetic electrons recirculating through the interior of the magnetic confinement system. At sufficiently large size (ca. 1.5 m and above) the neutral gas density and electron edge density will be such that ionization of the background neutrals will occur in only 1.2 cm of electron path length, thus there will be no need for separate ion injection to supply ions to the system. Further, the electrons created from this ionization will all appear at low energy and will be heated by further collisions with the fast/energetic electrons of the injection beam-driven system, so that they will reach injection energy within a few microsec. By this means, fusion fueling may be accomplished by the simple expedient of neutral gas supply into a heavily driven large scale system. Unfortunately this can not work in small scale devices as the densities and dimensions are insufficient to allow adequate ionization of the gas supplied.

In FIG. 12 numeral 900 designates a first positive ion injector. First positive ion injector 900 includes a gas inlet 910, an ionizing region 915, an accelerating grid 920 and an annular beam lens 930. Thus, first positive ion injector 900 is constructed and arranged to produce an annular beam centered on one of the axes of the truncated cube system.

Numeral 940 designates a first electron injector. First electron injector 940 is also centered on an axis of the truncated cube, and is constructed and arranged to direct an annular electron beam to the center of the interior volume of the truncated cube. First electron injector 940 includes an electron emitter 950 electrically connected to an emitter power source 955, and an accelerating grid 960. This grid is held at an electric potential +V above that of the emitter, by an electron grid power source 965, thus producing a central potential well depth of −V (FIG. 7A). Emitter/repeller plates 102 of FIGS. 10A, 10B, 11A, 11B and 11C may be similarly constructed.

Additional injectors may also be provided. FIG. 12 illustrates the provision of an additional injector of each type, a second positive ion injector 970 arranged symmetrically opposed to the first positive ion injector 900, and a second electron injector 980 arranged symmetrically opposed to he first electron injector 940. The details of construction of these additional injectors will in general be the same as that of the opposed injector of the same type. Thus, these details have been omitted from the drawing for clarity and will not be further discussed here.

Details for injector placement on the surface of an octahedral system are substantially the same.

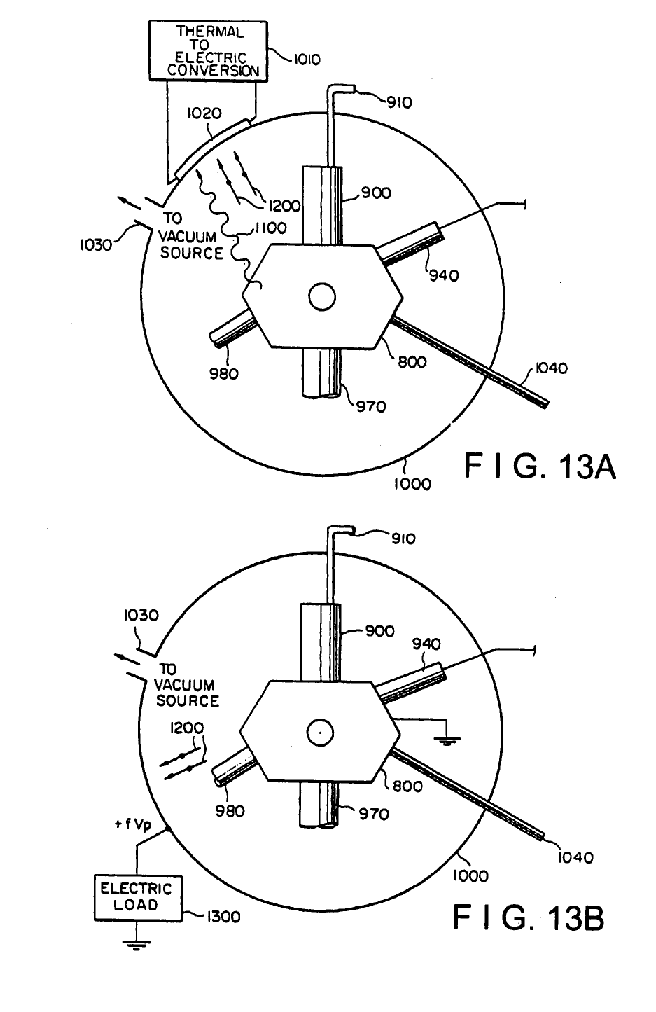

FIGS. 13A and 13B illustrates one possible arrangement for the truncated cube systems as a heat-generating element in a power plant. Truncated cube electron confiner 800 is shown in a cross-section taken along line X-X of FIG. 12. The system is placed with its associated injectors 900, 940, 970, and 980 in an evacuated containment structure 1000, depicted as a circular shell. As shown in FIG. 13A, containment structure 1000 is heated by absorption of radiation 1100, and by collisions with particles 1200, generated by the fusion reaction occurring in truncated cube region 800. This heat is thermally coupled to a heat exchanger 1020 (section of heat exchanger shown) in which a working fluid such as water absorbs heat. The heated water is then conveyed through thermal to electric conversion unit 1010 which converts the heat energy stored in the water into electrical energy. Thermal to electric conversion unit 1010 may be any known means for converting heat energy into electricity. FIG. 13B shows one arrangement for direct electrical conversion of fusion product particle 1200 energy by causing the particles to travel outward against a positive electrical bias fVp applied to the containing shell 1000.

The containment structure 1000 is evacuated through conduit 1030. The truncated cube electron confinement device 800 is cooled via cooling channel 1040.

Electron surface losses through the confining magnetic field will limit the power balance performance (i.e., the system power gain) of such devices. However, a simple (over)estimate of maximum potential system gain can be obtained by balancing electron injection requirements with ion makeup needs to replace ions burned up by fusion reactions in the confined core. This method ignores surface electron losses, and limits electron power needs to internal requirements for ions for fusion, only. If scaling of the fusion power is constrained by limiting energy flux through the boundaries of the device, then it is possible to calculate a maximum upper limiting system gain value (G+), as just defined, for any size of machine.

Although unrealistically optimistic from an engineering standpoint, the results of such an analysis show absolute upper limits on system power gain. These (G+) values vary roughly linearly with system radius R. The size of such devices can range from R.10 cm radius to a radius of several meters (e.g., R.≈3 m). Some crude estimates of these parameters are given in Table 1, for systems operating on DT or DD fusions. The upper limit system gains possible for use of other fuels and nuclear reactions will be less than those shown, because operation with such fuels will require larger negative electric potentials than for DT/DD. The inclusion of realistic external loss effects, e.g. bremsstrahlung losses, transport losses to structures, etc, will yield considerably lower practical gain values from such machines.

TABLE 1
ELECTRON/ION BURN BALANCE LIMIT ON POTENTIAL
RANGE OF DT/DD SYSTEM PERFORMANCE

| B-FIELD | | REACTION | DRIVING | UPPER LIMIT |
|---|---|---|---|---|
| SURFACE | | POWER | POWER | SYSTEM POWER |
| RADIUS | | OUTPUT⁽¹⁾ | OUTPUT⁽²⁾ | GAIN⁽³⁾ |
| (R) | | (Pf, Mw) | (Pi, kw) | G+ = Pf/Pi |
| 10 | cm | 0.1-1 | 2.5-25 | 4-40 |
| 30 | cm | 1-10 | 8-80 | 12-125 |
| 1 | m | 10-100 | 25-250 | 40-400 |
| 3 | m | 100-1000 | 80-800 | 125-1250 |

⁽¹⁾Surface energy flux at radius R is 0.08-08 kw/cm²
⁽²⁾negative electric potential well is about 100-200 kev
⁽³⁾System power gain may saturate at about G < 1000

The smallest size of practical interest is that at which the device will yield net power from the fuel combinations chosen for use. It has been found that the power output of these devices scales approximately as the 7^{th} power of the device interior radius, R; thus Pf=C1(R̂7), for given conditions of drive energy (set by choice of fuel). Further, that the power gain (ratio of power generated to power required to drive the system) scales as the 5^{th} power of the size, Gf=C2(R̂5). Normalization of these scaling laws has been done to a variety of experiments and it has been found that the minimum practical size for DD systems is about R=1.5-2 m, and for pB11 systems is about R=2-2.5 m. Both for a plant output of about 100 MWe. Since the scaling is so rapid with size, a small increase from the 100 MWe size suffices to yield 1000 MWe. Conversely, it is clear that there is little interest in building systems at (e.g.) half of this size, as their output will be quite small for large scale applications.

For large system designs such as for a power plant size device, it is both practical and sensible to use super-conducting magnets for the provision of the confining B fields. Further, the requirement of minimal unshielded metal surfaces, to avoid electron losers, is much easier to attain in a large machine than a small one, as is the provision of inter-coil supporting means in ways to avoid unshielded surfaces.

Power losses due to cross-field electron transport will dominate the real power balance gain in larger devices. Their assessment can be made using electron transport coefficients, as discussed below.

The fusion power density of operation is given by the product of ion density squared and the fusion cross-section product with the ion speed within the well. Since both the speed and cross-section increase with increasing well depth (in the range of interest here) the power density will be determined (strongly) by the depth of the confining electrostatic well in the central plasma region. Larger well depth will lead to larger power density for the particle reaction power. If this power output is limited to yield a constant surface flux of energy generated within the system, the required confining well depth will become smaller as the device size is made larger.

The ion density which can be sustained in such a system will be limited by the ability of the fields (both electric and magnetic) of the confinement system to support the pressure required by the ion density at the temperature of operation (i.e., at the “temperature” of particles at the energy of the well depth). This is reflected in the requirement that the surface electron density be maximized at that value at which the electron energy density is exactly equal to the magnetic energy density of the confining fields at the surface. Thus, the kinetic pressure p=nE of the plasma must be balanced by an external pressure force to sustain it stably. The external pressure force is just that due to the energy density of the magnetic field, B²/8 π. Electron density can never exceed the value set by this equality, as any higher electron density will cause the confining field to expand in the cusp regions and allow a larger escape area for the electron flow.

For the static confining fields of the so-called “magnetic confinement” approach either the volumes are so large or the magnetic coil currents are so large that net power balances appear questionable. In the device concept and invention claimed herein these limits are overcome by the use of the kinetic/potential exchange or transformation resulting from the circulating electron and ion current, through the confining electrostatic potential well region, as the means to couple momentum pressure support from a high pressure central core to a low pressure external surface. In effect the circulating (or oscillatory) centrally-convergent currents act as a special type of “gas” which exhibits a strong radial kinetic pressure gradient such that its kinetic pressure is very large at the center and small at the periphery of the electrostatic well region. Analysis of the current requirements for pressure balance shows that the net system gain G (for given surface injection current density) is related to the cavity current amplification factor Gⱼ and the system characteristic radius by G=C1 (R**⁵) (Gj**²). The coefficient C1 is found to be approximately C1=3.0E-17/cm5 for R in cm. For a “break-even” system, G=1, and a current amplification of Gⱼ=1.0E5 is required for a system radius of R=20 cm. Conversely, without any current amplification at all in the system, Gⱼ=1, and G=1 will be attained at a system radius of R=2000 cm=20 m. Both of these extremes are practically infeasible, and realistic systems will be found in the range of R=1.5-2.5 m, as previously discussed. Amplification factors of 1E6 and higher have been attained in a variety of electronic high power tube devices. However, values much less than this are readily attainable, as discussed above, and are enough to yield net power systems of respectable overall gain.

Another physics feature of importance in system operation is that the fusion products will, in general, not deposit their energy in the plasma region (as in the case in “conventional” concepts for fusion), but will escape from this region to the structures and surfaces bounding the polyhedral magnetic/plasma system. In this escape, these particles will leave as positively charged ions, thus increasing the net negative potential of the plasma region. Each fusion event will cause an increase in the well depth which is confining the reacting ions, hence will cause an increase in the particle density and resulting inter-particle reaction rate which will, in turn, cause a further increase in the negative potential, the well depth, etc., etc. The onset of fusion reactions in a negative potential well of the type contemplated herein will thus initiate a self-generating process to increase the well depth and thus to increase the fusion rate. Under certain special conditions (of total recirculating ion current) it is possible, but not certain, that-once started-a reacting assemblage of this type could become self-sustaining without any further excess external electron injection, beyond that needed for balance with the ion injection rate itself. In any case, this self-generating-well effect might allow the reduction of electron injection for well sustenance, and thus could result in a reduction in the externally-supplied power required to drive the electron injection system.

Another key feature of embodiments of the present invention is the placement of the electron sources outside and around the machine (i.e., outside the magnetic field coils). These emitter/repeller plates 102 can be simple active emitters in the form of filamentary electron emitters, heated by ohmic currents, and emitting electrons according to a modified Child-Langmuir law. These are placed on-axis of the main faces of the polyhedral field geometry, and biased negatively with respect to the device itself. By this means, the device coils become the accelerating potential drivers for extraction of electrons from the emitters. The machine coils may be at high positive potential and the emitters at ground potential, for example, in which case the external shell or cage surrounding the entire system within a vacuum pumping system will also be at ground potential. The only object at high electric potential, then, are the coils. Electrons from the emitters (emitter/repeller plates 102) will be emitted effectively only if they are located sufficiently close to the attracting surfaces of the machine. However, they must not be too close, else their potential difference will cause suppression of the well depth at the edges along the cusp axes. This “droop” would make ion confinement less attractive, and less feasible. The appropriate distance to place the emitters has been found to be at about that of the radius of the cusp face and more generally at about 1-1.5 times the radius of the cusp face on whose axis the emitters are placed. The droop then expected is less that 15% of the well depth. At further distance the extraction will be poor, and closer in, the droop will become excessive.

The term emitters/repeller plates 102 has been used herein to designate either active emitters (as shown in FIG. 12) or repeller plates. Repeller plates are not active emitters but rather generate electrons from secondary electron emission due to ion bombardment from ions escaping along cusp lines (because of the droop just discussed). It has been found by experiment that, given sufficient magnetic field trapping of interior particles, it is possible to run such a system entirely on secondary electrons from non-active repeller plates on cusp axes, if the B fields are above 500-800 G. These repeller plates must be positioned within a few cm of the cusp axes, as must the emitters, and at about the same distance from the machine (i.e., coils) as the emitters, just discussed. They must be held at ground potential (for the example given) by an external power supply, just as must the emitters themselves. Of course, the potential of the system could be inverted, with the machine and all surrounding structures held at ground potential, while the emitters and repellers are held at high negative potential, but the preferred embodiment is that of the first-above description.

Characteristics of embodiments of the invention include the following.

In order to reduce electron loses, it is preferable to have less than 1/10,000 of all surfaces. unshielded. Most desirably, no B fields should intersect any metal surfaces in the system. To this end, all coil containers should be substantially conformal in shape to the B fields they produce.

Coil corner spacing must be at least 3 electron gyro radii and up to 10 or so, but not markedly greater;

It is necessary to keep the pressures between the magnetic coils 101 and the walls of the vacuum tank 109 below the Paschen arc limit for the system since otherwise one would encounter arc breakdown and shorting of all the driving power supplies, by arcing, for example, to the vacuum tank walls. One way to achieve operating below the Pashen arc limit is to have large vacuum pumping systems as described above. Alternatively, with smaller pumping systems one may operate in a pulsed mode using large amplitude short duration currents to the field coils and a “puff” gas mode in which a small amount of neutral gas is introduced quickly into the interior of the machine. The amount of gas introduced in the puff mode is sufficient to provide relatively high density inside the machine coils, sufficient to achieve beta=one conditions, but only for a relatively short period of time. Introducing the neutral gas for too long a period of time would produce undesired Paschen arching outside the machine coils. The time of inputting the puff gas is thus long enough to ionize the input gas, trap the electrons and form a deep well, and trap the ions to make fusion at the interior high density. As an example, it may take approximately 1-2 msec after puff-gas input for sufficient gas to leak from the interior of the machine to the area between the coils and the vacuum vessel. However, since a representative electron lifetime in the machine is about 0.1 microsec, even 1 msec is 10,000 lifetimes, so the process looks like “steady-state” to the electrons (and their trapped ions).

Internal operating density should preferably correspond to a starting pressure of 1E-2 to 1E-3 torr (density of 3E13 to 3R14/cm³).

Electron driver sources, e.g., e-guns should be placed substantially on-axis (not be more than 1-2 cm off-axis) at the faces of the point cusps, close enough to avoid mirror reflection rejection of the injected electrons. Secondary electron generating plates (by ion impact) can be used on-axis to enhance electron input.

The distance from machine (e.g., coils) to external tank wall or screen potential Faraday cage must not be more than approximately half the adiabatic capture radius for electrons in the external region (i.e., electrons must stay “glued” to B field lines even externally). Further, the device must be held at high positive potential while the e-guns/sources and external walls are at ground potential. Optionally, microwave ionization may be used to ionize neutral gas just inside the interior edge fields, so as to avoid neutral gas wall reflux.

In addition to the above characteristics, the overall system of course uses polyhedral fields with point cusps with every vertex surrounded by an even number of faces (to avoid line cusps), electron injection on-axis, the use of low energy ions injected at the interior field edge if so chosen.

Embodiments of the invention discussed herein offers the ability to create nuclear fusion reactions in a wide variety of fuels. As discussed above, these range from the least-technically-demanding DT system, to the least complex and least costly DD system, to the radiation-free higher-Z fusion fuels (e.g. pB11, et al). Civil/commercial applications will favor the use of DD systems for the production of low-cost steam. Cheap steam can be used in conventional means for the generation of electricity, desalination of sea water, production of synthetic chemical fuels (e.g. alcohols, coal liquefacation, etc.), chemical and materials processing, etc.

Some exemplary reactions which may be feasible with the present invention proceed as follows. First, D and T can be made to yield DT fusion reactions according to:

D+T→He4+nf(14.1 Mev) (1)

### (Q=17.62 Mev),

and confinement of D alone can be made to yield (with equal probability) DD fusion reactions as:

D+D→He3+n (2a)

### (Q=3.28 Mev)

D+D→p+T (2b)

### (Q=4.03 Mev)

The T produced (in Eq. 2b) will react according to Eq. (1) with the D in the plasma, if the fusion product tritons (T) are contained in the system. In general, in the systems considered, most of the energetic (Mev+) fusion products will escape the confined plasma volume. The He3 produced (in Eq. 2a) will also react, if confined, by:

One other reaction is of special interest, since it is both neutron-radiation-free and has high cross-sections for fusion reaction at modest energies in the electrostatic systems of concern here. This is:

p+B11→3He4 (3)

### (Q=10.7 Mev)

DD systems do not require the use of externally-supplied T, and thus do not require breeding blankets of Li (in which T is produced by n capture in Li6), as do closed-cycle DT systems. Systems operating on D alone will generate a significant output of neutrons at moderate energy (about 2.5 Mev; see Eq. 2a) in the DD fusion process. However, if the T produced in the DD reaction mix (see Eq. 2b) is not contained or burned within the plasma, no energetic 14 Mev neutrons will be produced and the radiation hazard will be less that ( 1/10) that of a DT system (see Eq. 1) for operation at the same gross fusion power level. D (H2) is the least costly fusion fuel except for p (H1), which requires B11 or Li6 to generate radiation-free power. This fact and its relatively low radiation hazard potential make it a good candidate for use in civil/commercial/industrial profit-making energy plants.

In such energy plant use, it is contemplated that the fusion device will be sufficiently small in size and low in cost that it can be operated to destruction or end-of-life (as set by neutron damage to the structure of the system) without on-line maintenance, and may be removed, disposed of and replaced at such time. In this fashion, its in-plant application method resembles that of other compact fusion devices. See, for example, U.S. Pat. No. 4,367,193, issued to the present applicant. However, except for use of DT fuel, no Li blankets are needed, and the fusion unit to be removed and replaced here need be only the magnetic coil system of the current invention, not necessarily including its ion and electron injectors. Such removal and replacement is not unique to fusion plants; similar exchange of power sources is made in jet aircraft whenever the turbojet engines reach their point of allowable wear or end-of-life, and to electric light bulbs which are replaced when they fail while the electric power plant supplying electricity to their sockets continues to operate.

As previously noted, DD fusion systems may produce energetic DT fusion neutrons (14.1 Mev) if the T produced in half of the DD fusion reactions (Eq. 2b) is captured and fed back into the plasma region to be burned. Since the DD process, in the invention discussed herein, does not require T for its startup or its continuation, no breeding of T is necessary for such DT reactions in a DD system. Thus all of these energetic neutrons, as well as all of those lower energy neutrons resulting from the other half (Eq. 2a) of the DD fusion process, are available to be used for the nuclear breeding of T or of fissionable fuels, or for the burnup of radioactive nuclear wastes. Thus, any DD-driven plant can also be designed to produce neutron-generated products as well. For example, a plant producing electricity might also use its output neutrons for the transmutation/burnup of fission product wastes from conventional nuclear reactors. It is estimated that DD systems which burn all of the T they produce will be capable of breeding 2-3 times as much transmuted product as is potentially possible in conventional fusion reactor plant concepts, and up to 20-50 times as much as from fission breeder reactors (e.g., Phenix-II of LMFBR).

Also as noted before, nuclear fusion reacting systems of the type herein will not generally confine the charged particle products of the reaction. These all appear with sufficient energy to escape the externally-driven ion-confining electrostatic potential well, and will not be confined by the magnetic fields used to support the electrons required for maintenance of this electrostatic well. They may be collected on the walls or on any other structure of the system outside the confined ion-plasma region. Since they are charged particles this method of operation offers the prospect of the direct conversion of their energy to electricity, by the imposition of a high positive potential on these surrounding walls/structures. Thus according to embodiments of the invention, one may employ the production of electrical energy by direct conversion of the energy of fusion product particles from their generation in devices of the type considered herein.

In DD systems the He3 and T produced can be collected and recycled back into the system for further fusion reaction and additional energy release with the D ions therein. In particular, to avoid the ultra-fast neutron of the DT reaction, the T can be stored (e.g. as HTO in normal water, until it decays into He3 gas, which can then be recycled into the system) and the He3 produced can be separated in the external vacuum system and fed back into the fusion plasma region, to burn as D+He3. This has been called the DdcatA system. Its virtue is that it raises the average energy released per DD reaction to over 10 Mev. Then, if the stored T decaying to He3 is used as a source of further He3 for reburn in the system, the average energy will be increased to over 14 Mev per DD reaction. This is called the DdcatB cycle. At these energies, the DD system approaches the energy output of the DT cycle without any of the latter's very bad radiation hazard properties.

Alternatively, the He3 and T products escaping the system could be collected and used as fusion fuel in DT or DHe3 fusion systems located elsewhere. Given a fusion system capable of burning DD, there appears little incentive to use DT fuels for civil/commercial applications. Conversely, burning high-neutron-output DT offers certain new and unique capabilities in military systems not previously attainable by any other means, and such systems seem especially useful for military applications.

Fusion by use of DT fuels can be accomplished in the system of the invention described herein with smaller central electric potentials than are needed for DD (or for any other fusionable fuels). Such DT fusion systems have the property that 80% of their output energy appears as 14.1 Mev neutrons. This highly radioactive neutron output makes then of potential use for various national defense missions, e.g. as small mobile ground-based radiation weapons, for remote irradiation of military targets with thermonuclear neutrons.

Their small size, low power consumption, and mobility also make such systems uniquely suited to a variety of military uses in the space environment. These include systems for remote inspace irradiation and radiation-counting inspection, radiation damage or kill of opposing spacecraft and equipment, etc. Calculations of neutron spectral output from such systems show that their spectral energy distribution is similar to that from relatively “clean” “hot” thermonuclear bombs, thus they could also be useful for some aspects of TN weapons output simulation.

The large output and low cost of the energetic neutrons which constitute the output of DT burning systems make these ideally economically suited for use as neutron sources for the breeding/production of a variety of nuclear fuels and other isotopes. These include reactor grade nuclear fuels (e.g., approximately 3.5% enriched in U233 or Pu239, etc.), weapons-grade fissionable material, low-cost T, and a variety of special trans-uranium isotopes which have unique uses in nuclear weapons systems.

Finally, if negative potential well depths of 150-220 kev can be produced and maintained stably, as embodiments of the current invention indicate, it is possible to burn non-radiative or radiation-free fusion fuels. The preferred fuel combination here is that of p+B11, which yields only He4 as fusion products. It should be noted that boron is the 10^{th} most plentiful element in sea water, and that its cost is very small as compared with its ability to produce energy through the processes and machines discussed herein. B11 is 80% of natural boron, so that it is possible to run a pB11 system on natural boron, with only a 36̂ reduction in output power, thus eliminating any need for isotopic separation. The radiation-free character of this system makes it of great potential value for both military and space systems, in which humans are involved, and for eventual dominant use in commercial power plants, which can best utilize such clean, non-neutronic power sources. Application to space propulsion engine systems for rocket propulsion yields very high performance levels, exceeding conventional means by factors of 10-100; and to small, non-hazardous and light-weight space electric power systems; mobile military power plants; surface ship and submarine propulsion systems which do not require any significant shielding; and even radiation-free unshielded propulsion systems for aircraft, as well as to all levels of commercial power plants for electricity production or for production of process steam, for example. In any of these systems, the fusion products may be allowed to escape the confined plasma region and their energy may be converted directly to electricity, if desired.

While, as discussed above, embodiments of the present invention may be utilized for production of electrical energy, it will be appreciated that systems and methods described herein may be applied advantageously in other applications which do not require net energy gain or even break-even. For example, the present invention may be employed for production of neutrons for use in various applications in addition to energy generation. As noted above, such applications include nuclear breeding of T or of fissionable fuels, the burnup of radioactive nuclear wastes, and TN weapons output simulation. Further, the devices and methods described herein are also suitable for nuclear assay applications such as detection of fissionable material, such as highly enriched Uranium (using either delayed neutrons or differential die-away), detection of high explosives, detection of drugs or poisonous gasses such as mustard gas. These applications generally require neutron yields in the 1.0e8 neutrons/second to 1.0e11 neutrons/second range and can be used with either D-D fusion or D-T fusion. Energy gains as low as 1.0e-5 to 1.0e-4 are suitable for these applications. Thus, the utility of the present invention is not limited to applications requiring net energy gain.

### Experimental Results

The following summarizes the results of experimental tests of systems of the type described above conducted at the Energy/Matter Conversion Corporation (EMC2). These experimental tests are further described in R. W. Bussard, Proceedings of the 57^{th} International Astronautical Congress, (IAC2006), which is incorporate by reference herein in its entirety.

The EMC2 experimental R&D effort began in 1994 with design and test of a small machine (R=5 cm), called WB-1, to verify polyhedral B field effects. This device utilized uncooled solid-state magnets in a truncated cube arrangement, and was simple to build and test, but inherently had circular line cusps on all its main face magnets. This resulted in electron loses through these line cusps, but experiments showed electron trapping within these limits. This was succeeded by WB-2 (1994-95) another truncated cube configuration, with an interior half-width of R=5 cm, but with uncooled wound coil magnets on all six main faces. WB-2 tests proved the principal effect of internal cusp confinement of electrons under high current drive conditions. Subsequent tests were made on similar but larger machines, WB-3 (1998-2001) and WB-4 (2001-2003) with R=10 cm and R=15 cm, respectively.

All of these machines were tested inside vacuum tanks and had open faces on all cusp axes (the main faces and corners) to allow full circulation of electrons out and back along the polyhedral B fields produced by the magnet coils. WB-4 produced fusions in DD under a short-pulsed-mode drive in December 2003, at about 1E6 fus/sec at 12 kV drive energy and 10 kV well depth. In parallel with this work, a closed-box machine (PXL-1) was built and tested to study electron cyclotron resonance (ECR) ionization of internal background neutral gas, and ion focusing in negative potential wells. Even though it was driven by a single electron emitter, its tests showed good ion focusing to the potential well center of the device. It did not allow electron recirculation from the interior of the device and thus was limited (by wall collision losses of electrons) in its ability to reach high electron densities. Also in parallel, two single-turn, water-cooled, polyhedral tube/coil devices (MPG-1, 2) were built and tested at low B field but high voltages (2001-2002). Both showed DD fusion reaction output with deep potential wells. And, also in parallel, a fast- pulsed adiabatic compression device (PZLx-1) was built and tested (2002-2003) to study hydromagnetic stability of the polyhedral fields under static and dynamic conditions. This device was a single-turn solid copper coil system driven by a fast capacitor bank energy system to 35 kG central fields, in ca. 2 msec. This was limited by Paschen arcing to starting energies (of electrons) of about 300 eV, but produced 1E6 fus/sec in DD at its pulsepeak.

A larger version of the closed box device (PXL-1) was built as WB-5 (2004-2005), to test improvements in magnetic insulation by use of external surface and cusp coils at high fields. Its test results showed 1000-fold improvement (in ability to reach deep fractional well depth at given starting pressures; early work was limited to 3E-9 torr, while WB-5 ran at 3E-6 torr) from early work on a larger closed-box machine but its inability to be driven beyond this increase illuminated the critical and dominating effect of unshielded surface losses of electrons, on overall system performance. This is discussed further, below. The insights gained from test of this device led to new engineering physics design constraints, which avoided such loss phenomena, and which were included in a new machine, WB-6 (2005). This was built and tested (October/November 2005) with impressive results, giving DD fusions at over 100,000× higher output (at 1E9 fus/sec) than all prior similar work at comparable drive conditions. All testing was necessarily short-pulsed (discussed further below), but all basic engineering design conditions were proven by this machine (together with the results from its predecessors), to enable design of a full-scale power plant system.

Thus, all of the individual physics issues and effects required to make the concept work have been proven by the extensive experimental tests made since 1994 in the EMC2 R&D program. These include:

The WB cusp trapping effect (explained further below; WB-2, 3, 4, 5), its physics and numerical rates.

The need for electron recirculation through all cusps of the machine, so that cusp electron flow is not a loss mechanism.

The consequent elimination of the WB trapping factor as a measure of “losses” it is simply a measure of density ratios inside and outside the machine.

The ECR means for neutral gas wall reflux suppression (PXL-1, WB-3, 4).

The ability of machines to act as electron extractors from e-emitters located on axes (WB-2, 3, 4, 6).

The appropriate on-axis positioning of such emitters relative to machine dimensions (WB-4, 6).

The restrictions on machine relative dimensions due to electrostatic droop from emitters and external walls (extensive electrostatic computer simulations/codes).

The proper positioning of external walls and choice of neutral gas pressure for suppression of arcing (every machine tested).

The conditions for arc faulting in machine operation (every machine tested).

The need for injection of neutral gas INTO the machine interior, and for immediate ionization of same (WB-4, 5, 6), or

The requirement of ion gun injection at the interior edge of the Polywell potential well within the machine (WB-4, 5), while keeping external neutral gas density low by extensive pumping.

The inherent hydrodynamic stability of the Polywell trapping polyhedral B field configuration (PZLx-1).

The production of predictable fusion reaction rates within the interior of deep- well Polywell devices, at both low and high B fields (WB-4, 6, MPG-1, 2).

The ability to run Polywells at current drives up several thousand amps of electron injection (WB-4, 5, 6).

The determination of electron transport losses across Polywell B fields, and verification of the electron transport loss phenomena (MG transport coefficient) by extensive experimentation in all Polywell machines.

The necessity of avoiding magnetically unshielded surfaces in any machine design.

The understanding of the effects of finite coil dimensions on the role of cusp “losses” at corners, and the resulting need for precise construction at these points (see above), i.e. spacing at several gyro radii.

The need for magnetic field coil containing structures to be conformal with the B fields they produce, to avoid excessive electron impact losses (as above).

The need for independent electron guns to provide adequate drive power.

The ability of ion-impact secondary electron emission to supply large drive current capabilities in proper Polywell machine/shell systems (WB-5).

The requirement of large drive power, as defined in the original Polywell design and configuration concept.

Several conclusions can be drawn from the research results discussed above, including:

1. Essentially all the research and development work that can be usefully done at the small scale has been done.

2. All of the basic physics effects and engineering design and construction constraints have been done allowing their extension to full scale sizes (e.g., 1.5 m for DD, 2 m for pB11).

3. The results of all of the experimental studies to date have shown physics limitations that suggest engineering configurations and designs to use of fully electron-recirculating machines, within external vacuum shells or Faraday cages, with only the internal machine at high electric potential. In this arrangement, the electron emitters/sources and the external shell are all at ground potential.

4. An alternate potential arrangement could be used, in which the only elements at high negative potential are the emitters. This can work if it employs driven, negatively biased repellers at every cusp axis position, to prevent excessive electron loss by streaming out along each axis. Such repellers could also act as secondary electron emitters (from ion bombardment) to the degree that the primary driven emitters may be turned off, as shown in tests on WB-5.

5. In these systems electron loss phenomena are primarily to (metal) surfaces of the machine system. Cross-field losses are well understood and can be controlled. However, losses to poorly shielded (by fields) or unshielded surfaces can constitute major loss channels. From WB-5 and WB-6 it has been shown that that the fractional area of unshielded surfaces must be kept below 1E-4 to 1E-5 of the total surface area, if electron losses are to be kept sufficiently small so that net power can be achieved. And, further, that no B fields should be allowed to intersect any such internal surfaces of the machine.

6. This requirement has two main consequences: (a) All coil containers/casings should be of a shape conformal to the B fields produced by their internal current conductors, and; (b) The finite size of real coils forces design so that no coils/containers should be allowed to touch each other, but all corners should be spaced at some distance from the adjacent coils, to avoid B field intercept.

7. This is the principal criterion for design and construction of any real, finite material coil and system, no matter the plan-form shape of the coils, which is of no major significance (i.e. round, square, polygonal or triangular, etc). The spacing between coils should be such that the central plane B field is approximately the same as that of the B field on main face axes. Typically, this may be at minimum the order of a few (5-10) electron gyro radii at the inter-corner field strength, but not greatly larger than this (to avoid excessive degradation of the internal WiffleBall—WB—electron trapping factor in the machine main field. This Wiffle Ball trapping factor (Gwb) is not a measure of losses in any recirculating machine, thus its value need not be as large as those potentially possible with high B fields (1E3 vs 1E6), thus greatly relaxing the need to strive for super-high Gwb factor values.

8. This Wiffle Ball trapping factor (Gwb) is NOT a measure of losses in any recirculating machine, thus its value need not be as large as those potentially possible with high B fields (1E3 vs 1E6), thus greatly relaxing the need to strive for super-high Gwb factor values.

9. Wiffle Ball behavior is of value to establish the density ratio from the machine interior to its exterior, and this is important to assure suppression of Paschen arc breakdown outside, which destroys the electron injection drive and well potential.

10. These considerations have been driven by the long array of experiments described above, first on WB-2, then some on WB-3, then the last series of WB-4, with parallel tests of unique-feature other devices, MPG-1,2 and PXL-1, PZLx-1. Finally experiments were run in tests subsequent to these on WB-5, and lastly on WB-6, the final machine, with greatly reduced losses, and record-breaking DD fusion output.

The above described techniques for inertial-electrostatic fusion (henceforth the “Polywell” concept) are based on the idea of trapping high densities of energetic electrons within a quasi-spherical magnetic field, into which a current of high energy electrons is injected to form a deep negative potential well, without use of mechanical grids. Only a very slight fractional negative deviation (1E-6) from charge neutrality (of ions vs. electrons) is required to make potential wells nearly as deep as the electron drive energy. Ions then “dropped” into this well, at its edge, will fall to its center, with 1/r2 increasing density, and gaining energy sufficient to make fusion reactions among them as they collide in the central core region of this configuration. If scattering occurs, the ions simply recirculate back up the well and fall in again when they reach its edge. They are, of course, finally turned by their gyro motion in the increasing edge B field of the system, just as are the electrons. An important element in power balance (fusion power generation vs. electron drive power losses) is the ability of the magnetic field to keep electrons inside the quasi-sphere—ions remain trapped by the electron-driven electrostatic potential well. The phenomena of fusion generation and of electron trapping and losses are essentially decoupled in this system. Early work on this concept presumed coil conductors of zero cross-sectional radius, placed exactly along vertex edges, with sharp corners where coils came together. This configuration led to an odd point/radial-line at such corners which had zero field over zero radius.

The two single-turn MPG devices (MPG-1 and MPG-2), which were constructed to try to mock up the configuration of the coils, but with full recirculation of electrons (called MaGrid machines), did yield very deep fractional (90+%) wells, as expected. This was because the e- sources were all exactly on-axis, and were relatively distant from the main faces. This geometry yielded only a small angle subtense for the injected electrons, and thus only a small transverse spread of electron energy (relative to radial energy) at the device inner boundary (fractional well depth tends to vary as the square of the sine of the angular spread at injection). However the machines ran only at cusp axis fields limited to 70-100 G, because of engineering limitations on drive power, cooling, and system size. These simple devices were also built with spacings at the coil corner positions, so did not suffer from the unshielded loss problem discussed to above. They did work and produced fusions in DD. They functioned by trapping electrons in the polyhedral fields, to make deep wells—30 kV e-drive with 27 kV well depth—with ions generated near the outer edge falling in along the well gradients, as they should. Limited drive currents (e.g. 0.3 A) gave low ion densities, such that the trapped ions could not reach ion energy much above 4.5 kV before charge exchange with the background neutral gas prevented their further heating by ion/ion collisions. The limited small drive currents completely prevented burnout of this background gas. This resulted in the generation of significant beam/background fusion reactions (at about 1E4 to 1E5/sec) due to fast ions colliding with the background neutrals. The device was limited by limiting drive power and limited cooling ability on the coils. However, these machines did prove the efficacy of Polywell trapping and produced DD fusion output. Gwb in these two devices was of order 2-8, which is a very small Wiffle Ball trapping factor. Much higher Gwb values could be attained if machines were built with much larger B fields and at larger sizes. In the MPG series, cooling limits prevented higher currents, and multiple turns to get higher B fields were out of reach (due to, e.g., insulation breakdown in simple, multi-turn coils, at high drive voltages) with the available effort.

In order to make net power in a Polywell system of the types described above, there should be no more than about 3E-5 fractional metal surface area unprotected by magnetic field insulation. Otherwise, direct field-free electron losses will exceed both WB and MG transport power flows, and system may not be able to yield positive gain. Relatedly, closed box configurations typically cannot be made to function as a net power Polywell, with any currently available practical magnetic coil surface protection windings. I.e. it is not possible, in a practical, constructable system, to cover all but 1E-5 of a closed box system with protective fields. This means that the Polywell systems that can be made to work are typically those in which there is no metal surface exposed—this requires open cusp, recirculating electron flow, around B field coils that are substantially spatially conformable to the magnetic fields surfaces that they produce. This suggests that the coils be spaced at a significant interval at their corner “touching” points, to allow free electron flow through these points. This also makes the WB trapping factor simply a measure of electron density ratios (inside to outside) rather than a measure of “losses” to containing walls and structures. And, because of this, it is not necessary of achieve Gwb values greater than, at most, 1E4 rather than the 1 E6 required for non-recirculating machines

Thus, in order for a Polywell to be driven in the mode described above, open, recirculating MaGrid (MG) machines are preferred. This, in turn, suggests that the entire machine should be mounted within an external container surrounding the entire machine and that the machine be operated at a high positive potential/voltage (to attract electrons) relative to the surrounding walls. Note that this was the electric potential configuration used in the earliest MG machines, the WB-2 device, in the first proof of Polywell fusion reactions, and in MPG-1, 2, and in fusion production in the later devices, WB-4, 6.

One might raise questions concerning the ability of the device to maintain its quasi-monoenergetic energy distributions among the ion and electron populations. These are, of course, driven by the dynamic injection of fast electrons, and their subsequent loss to structures. One might be concerned that if electrons live sufficiently long in the machine they could become Maxwellianized (thermalized) and develop high energy loss distributions. However, this has been found not to be the case. The same arguments have been found for the ions, as well. Detailed analyses show that Maxwellianization of the electron population will not occur, during the lifetime of the electrons within the system. This is because the collisionality of the electrons varies so greatly across the system, from edge to center. At the edge the electrons are all at high energy where the Coulomb cross-sections are small, while at the center they are at high cross-section but occupy only a small volume for a short fractional time of their transit life in the system. Analysis shows that this variation is sufficient to prevent energy spreading in the electron population before the electrons are lost by collisions with walls and structures.

Similarly, for ions, the variation of collisionality between ions across the machine, before these make fusion reactions, is so great that the fusion reaction rates dominate the tendency to energy exchange and spreading. Ions spend less than 1/1000 of their lifetime in the dense, high energy but low cross-section core region, and the ratio of Coulomb energy exchange cross-section to fusion cross-section is much less than this, thus thermalization (Maxwellianization) can not occur during a single pass of ions through the core. While some up- and down- scattering does occur in such a single pass, this is so small that edge region collisionality (where the ions are dense and “cold”) anneals this out at each pass through the system, thus avoiding buildup of energy spreading in the ion population. Both populations operate in non-LTE modes throughout their lifetime in the system. This is an inherent feature of these centrally-convergent, ion-focussing, driven, dynamic systems, and one not found (or even possible) in conventional magnetic confinement fusion devices.

Tests made on a large variety of machines, over a wide range of drive and operating parameters have shown that the loss power scales as the square of the drive voltage, the square root of the surface electron density and inversely as the ¾ power of the B fields. At the desirable beta=one condition, this reduces to power loss scaling as the 3/2 power of the drive voltage, the ¼ power of the B field, and the square of the system size (radius). Since the fusion power scales as the cube of the size, the fourth power of the B field, and a power of the E drive energy equal to the E-dependence of the fusion cross-section (cross-section proportional to E to the s power), minus 3/2. For DD, s=2-4, while for DT, s=3-6 in useful ranges of drive energy. For pB11, the cross section scales about as s=3-4 over the system-useful range. Thus, the ratio of MG power loss to fusion power production will always decrease with increasing drive voltage, increasing B field, and increasing size. Because of this, it is always possible to reach a condition of power breakeven in these polyhedral electric- fusion machines, with any fusion fuel combination. This is not the case in Maxwellian, equilibrium fusion devices know in the art, as these are severely limited by ion collisional losses to their walls, and by bremsstrahlung losses from the denser but less-reactive distributions in their equilibrium plasmas.

Along with the experimental results described above, device and system operation and performance at startup conditions, at very early times, have been modeled by complex electrostatic computer codes, that determine the coulombic interactions between all particles throughout the system and plot trajectories and densities in the system. Results of these computations show conclusively that B-field intercepts with containing structures leads to excessive losses of electrons, as previously discussed. However, these early time computed results do not show the realistic effects of collective phenomena beyond startup (from low- to high beta). These have been readily modeled successfully by a major plasma phenomenological code (the EIXL code) developed by EMC2 since 1990. This is a 1.5-dimensional Vlasov-Maxwell code, in which diamagnetic expansion of B fields is included, particle collisions are estimated from density and energy distributions, fusion rates and output are calculated, bremmstrahlung losses are included, and which includes such phenomena as central core inertial-collisional compression effects which can apply to core ion compression in Polywell devices. Results of these and other simulations support the practicability and scalability of the devices under study. For example, fully kinetic particle simulations have indicated that one can find and maintain an equilibrium for a device if the device is properly programmed.

As previously noted, no Polywell can operate at all if arcing occurs outside the machine, between the walls and the machine, because this destroys the ability of the driving power supplies to produce deep potential wells. Thus the mean free path (mfp) for ionization outside the machine (inside the container) must be much greater than the external recirculation factor, times the machine-to-wall distance. Since the mfp for ionization is inversely proportional to the product of the local neutral density and the ionization cross-section, this condition can be satisfied, if the external neutral. gas pressure is made sufficiently small. In order to avoid external arcing, the densities thus required are very much too low to be of interest for fusion, thus the density inside the machine (at its boundary) must be very much higher than that outside. This ratio is the Gmj factor, which is the ratio of electron lifetimes within the machine with B fields on, to that without any B fields.

In contrast, in order to be of interest for fusion, the interior density should be above some numerical value for any given size of machine. Typically this requires electron densities at the interior boundary of order 1E13/cm³, or higher, while the exterior densities (of neutrals able to be ionized) must typically be below 1E10/cm³ or less. Thus a minimum value exists for Gmj (here, typically 1E3), below which a machine cannot give significant fusion or net power, independent of unprotected wall loss. Both issues must be solved simultaneously.

In any realistic device, the effective overall trapping factor is reduced from the pure wiffle ball mode by circulation through the semi-line-cusps at the spaced corners, which allow much greater throughflow per unit area than through the point cusps of the polyhedral faces. The line-cusp throughflow factor is called Glc. These two effects act as parallel lossflow channels, and combine to produce an overall trapping factor Gmj, which is the inverse sum of each of their contributions, as weighted by their fractional areas involved. Thus the overall trapping factor for inside/outside density ratios, is given by 1/Gmj=fwb/Gwb+flc/Glc, where the fractional areas are flc+fwb=1. Solving this algebraic identity gives the effect of corner flow paths on the entire Gmj system as Gmj/Gwb=1/[fwb+(Gwb/Glc)flc]. If corner flow paths are not to dominate the trapping, the second term in the denominator must be kept small relative to the first (WB) term, thus flc/fwb<<Glc/Gwb.

Analysis shows that line cusp corner spacing flow factors are roughly equal to the square root of the mirror reflection coefficient Gmr for point cusps at the corner field strength, thus Glc=(Gmr)^{1/2}. Gmr values may be as high as 80-100 in such machines, thus Glc=10 is a reasonable value for the corner flow. Using this, and noting that fwb must be close to unity, gives the approximate result that flc <<10/Gwb for effective operation. In a truncated cube configuration Gwb=(BR)̂2/110E, for B in Gauss, E in eV and R in cm. Typically, machines may have Gwb>1E4, thus the fractional corner cusp flow area must be flc<<1E-3 as required to maintain good density ratios from the interior to the exterior, to prevent arcing, and retain high enough density inside for useful fusion. Note that this condition does not relate directly to the problem of electron losses to unshielded structure, which is also determined by the fractional impact areas involved as well as by the degree to which local arcing may occur to focus high current density discharges in the system.

Arcing can take place inside the system whenever sufficient deviation from local B field insulation is driven by “pinch effect” currents to the otherwise shielded metal surfaces. The arc pinch B field is given as Bp=0.2Ip/rp, where Ip is the pinch current and rp is its radius (gaussian units), and Ip=π(rp)A 2(jp), where jp is the pinch current density (A/cm2), this becomes Bp=0.2 r(jp)(rp) for B in Gauss. Now the condition for arc formation is when the pinch field significantly disturbs the shielding main B field Bo, thus when |Bo−Bp|<<Bo. This yields the constraint that Bp/Bo<<1, or that Bo>>0.2π(jp)(rp). From magnetohydrodynamic stability theory (and copious experiments since 1955) it has been found that pinch discharges are inherently unstable if current densities and radii are above some defined levels in any system. The condition is approximately given by rb̂2>3E9[(Ee)^{1/2}]/ne; this yields rb>0.2 cm for typical conditions of interest. Thus, it is possible to suppress such effects by avoiding sharp corners and electric field focus points in the design and construction of the interior of device, so as to prevent the attainment of high current densities over very small areas in arc formation.

One issue presented is how to reduce capacitor-drive currents to the levels that are actually needed for useful experiments. This is a matter of controlling the overall circuit impedance Z of the machine test system as it runs. This impedance is simply the ratio of electron drive injection energy to the electron current e-losses to the machine (not to the walls and tanks) in machine operation. This, in turn, is dominated by the three factors in e-loss phenomena:

1. Direct MG transport through the B-shielded surfaces,

2. Electron losses to poorly shielded or unshielded metal surfaces, and

3. Losses due to local arcing. Thus Z=Ee/Iej, where Iej is the sum of these three e-loss current effects.

As discussed above, arcing can be suppressed and avoided internally, by proper design of the surfaces to avoid electric field-enhancing sharp corners and small areas. Poorly shielded areas, such as the interconnects between spaced corners of the coil systems, can be minimized by careful design to minimize area and avoid sharp corners, and by use of internal B fields produced by current carriers through the interconnects. And the main MG transport losses can be controlled by use of the well-developed transport models and equations. In general, the impedance can be controlled successfully, but only with proper care in design and construction of the devices.

On electron trapping: Since the ion density is nearly equal to (and thus set by) the trapped electron density, it is desired to have the highest possible electron density for the least possible drive current. This requires that the transport loss of electrons across the trapping B fields be small, and that their flow along the cusp axes of the polyhedral B fields also be kept small. Cross-field transport constitutes an unavoidable loss to coil structure, while cusp axis flow need not be a “loss” if the device is open and the electrons can recirculate along the cusp axes to the outside of the machine, thence to return along cusp axes field lines. As noted above, this type of recirculating machine with magnetically protected coil surfaces is called a MagneticGrid (or MagGrid; MG) machine. It requires that the machine, itself, be centered inside of a containing wall or shell, that is held at a potential below that of the machine proper, by the voltage used to drive the electron injectors.

Initially, when the electron density is small, internal B field trapping is by simple “mirror reflection” and interior electron lifetimes are increased by a factor Gmr, proportional linearly to the maximum value of the cusp axial B field. This trapping factor is generally found to be in the range of 10-60 for most practical configurations. However, if the magnetic field can be “inflated” by increasing the electron density (by further injection current), then the thus-inflated magnetic “bubble” will trap electrons by “cusp confinement” in which the cusp axis flow area is set by the electron gyro radius in the maximum central axis B field. Thus, cusp confinement scales as B2. The degree of inflation is measured by the electron “beta” which is the ratio of the electron kinetic energy density to the local magnetic energy density, thus beta=8πmE/B2.

The highest value that can be reached by electron density is when this ratio equals unity; further density increases simply “blow out” the escape hole in each cusp. And, low values of this parameter prevent the attainment of cusp confinement, leaving only Gmr, mirror trapping. When beta=unity is achieved, it is possible to greatly increase trapped electron density by modest increase in B field strength, for given current drive. At this condition, the electrons inside the quasi-sphere “see” small exit holes on the B cusp axes, whose size is 1.5-2 times their gyro radius at that energy and field strength. Thus they will bounce back and forth within the sphere, until such a “hole” is encountered on some bounce. Analyses show that this factor can readily reach values of many tens of thousands, thus provides the best means achieving high electron densities inside the machine relative to those outside the magnetic coils, with minimal injection current drive.

In a recirculating MG machine, this factor is important since it sets the minimum density that can be maintained outside the machine, for any given interior edge density, as required for sufficient fusion production. It is desired to keep this outside density low, in order to avoid exterior Paschen curve arcing, which can prevent machine operation. To have low exterior density of electrons, and high interior density requires large Gwb factors, thus, good Wiffle Ball confinement is essential to system operation at net power.

From design and experimental studies it has been found that machines able to operate in steady-state mode require internal cooling of the magnet coil windings. This has been found impractical at the B fields required for useful fusion production, in machines below a size considerably larger than those which have been able to be studied. In particular, it has been found, by detailed design studies, that superconducting (S/C) magnets can not be used practically in machines below a size of, typically 1.5-2 m radius. Below this size, water-cooled copper coils occupy less total volume (because of S/C LHe/LN2 cooling requirements) thus are more practical to build. However, water-cooled copper coils with optimal shape and configuration (for minimum electron impact losses to coil structure), able to reach conditions useful for significant fusion production, also can not be made practically below a machine size of about 1-1.5 m radius. The limitations of water-cooled copper coils made it impossible to achieve B fields above about 3 kG in the WB-4, 5, 6 test machines.

In such Polywell devices, the strength of the B field is determined by the total current used to create the magnetic field from its driven coils, divided by the system size/radius. This current, in turn, is fixed by the limiting current density (j+) that can be used in the coil conductors, times the cross-sectional area of these conductors. This latter is proportional to the square of the system size (for similar configurations), thus to R2, as for the electron losses, above. Hence the maximum possible B field (for given limiting j+) is proportional directly to system size.

The engineering design configurations for normal (i.e. copper) coil conductors that can be properly cooled have been known since the beginning of this program. These require triple layer shells and internal insulation, and expensive and large scale tooling, and they can be used only in machines much larger (i.e. 1.5-2 m radius and up) than any currently built. Machines below this size have been built with higher B fields (and thus low electron transport losses) and can be tested in Polywell mode, but only as pulsed, uncooled-coil machines. This limits their testing ability to, typically, a small fraction of a second (due to ohmic heating of the copper coils of the magnets).

It is thus not possible to test at steady-state all of the physics working in concert, in a Polywell machine, in devices below about 1.5 m in size/radius. This fundamental fact, driven by the realities of mechanical and thermal engineering design and construction, has made it difficult to reach the objective of a break-even fusion power machine at the sizes and scales used in the experiment described above. However, to achieve this objective, machines in a larger size range may be used.

Due to such size limitations, WB-6 was designed as a short-pulsed machine. It was an uncooled machine, with its magnets able to run only for a few seconds at high field, and it had to be driven with large, difficult to control, capacitors, to reach the e-drive currents known from basic theory to be needed (40 to a few 100 amps).

The use of pulsed drives also forced the system to try to achieve large in/out neutral gas density ratios without steady-state e-driven burnout but had to make use of puff gas injected into the machine on submillisecond time scales, trying to match this with the fast discharge time of the caps; into the circuit of the machine, which was not even fully damped (RLC parameters could not be made fully stable with the equipment available).

Despite these limitations the proper course to follow to reach net power is known. WB-5 was an attempt to revisit to the first large scale closed-box experimental work to see how well electron confinement had been improved by the understanding of MaGrid insulation reached in the tests of WB-2,3,4 and MPG. It was expected that greatly increased electron trapping would result in higher electron densities at higher system starting pressures, at the same currents of e- drive. It was found that electron trapping was 1000× better than in earlier large machines, with comparable electron densities at pressures over 1000× those attained in earlier work. However, when increased drive currents were employed to try to drive the internal densities to still higher values, the machine was unable to go significantly beyond this 1000-fold increased level, except with extreme higher currents (30 kA and up). Extensive detailed experimental studies showed that this was due to e- losses along B-field intersect lines into the corners and seams (where the B fields run directly into the tank metal) of the containing tank.

WB-5 was a closed box machine, with its coils outside—so that it could not allow e- recirculation out and back through its magnetic cusps. These losses were extensive, and attempts to reduce them by use of floating ceramic repellers placed along about ½ of the seam lines reduced e-losses by 2.5 xs but only at the price of opening up huge loss areas for trapped ions. This did show exactly how extensive the unshielded metal problem was. No matter the shape of the coil/coil joint (whether sharp-corner touching or line cusplike) what matters is that (almost) no metal must be there at all. The coils should not touch and should be spaced apart. This is the electron-loss analogue of the effect of line cusp flow paths at the spaced corners on overall trapping factors, discussed above.

It was know that conformal magnet coil cans/casings were the way to avoid B field intersect with their surfaces, but due to size and cost restraints, the design and construction of WB-6 used uncooled coils that could only be run in a pulsed mode. As discussed above, the insight derived from the experiments on WB-5 was used in the design=and construction of WB-6, which did use conformal coil cans and spaced coils. The tests of WB-6 proved (by beta=one tests) to be an order of magnitude better in effective e-losses (i.e. losses greatly reduced) than WB-4. That is, the coefficient in the simplistic one-term MaGrid (MG) transport equation (for transport across the fields to the metal surfaces) normalized to experiment out at about 0.1 of that found from the WB-4 test results. This means that the effective unshielded metal surface fraction was greatly reduced in WB-6 from that of the metal structures (legs, doghouses, etc) of WB-4.

The actual loss equation must have three terms for realistic modeling of the phenomena here. The first term is the simplistic one, referred to above, the second term is that concerned with electron losses to less-well-shielded or unshielded metal areas and the third term is that concerning local arcing, discussed previously. Tests of WB-6 were made with the fast puff-gas/cap discharge system, starting at <1E-7 torr tank pressure. These four tests showed true Polywell potential well trapping of ions at ca. 10 kV well depth (with a 12.5 kV drive), with total DD fusion neutron output of ca. 2E5 nts over a period of about 0.4 msec; giving an average fusion rate of about 1E9 fus/sec—over 100,000 times higher than the results achieved in the art for DD at such low energies, and 100× higher than their best with DD even at 150 kV These results have shown world record output.

These results show, firstly, that Polywells, driven properly, do work and, secondly, that the operation of these machines is well understood and thus one can design and build full-scale systems with confidence. For the steady-state operation of the basic concept, what is needed are large controllable power supplies, much larger machines (but still only to about a maximum size of 2 m radius), and controllable gas supplies and e-guns able to survive their B and E fields and gradient environments. With these the machines can be driven initially via internal neutral gas burnout, and can use the “two-color” electron energy/density method. This two-color effect (starting with “dense “cold” electrons and transitioning very rapidly to less dense “hot” electrons, by energy exchange collisions with incoming injected electrons) will occur automatically in any machine, as employed in the pulsed cap-driven tests of WB-4 and WB-6, if background neutral gas is used by fast electron injection as a source for initial ionization within the machine.

As previously discussed, prior testing by applicant revealed that a key to successful operation of any “Polywell” machine is to minimize electron losses, which are the dominant power losses in the device. To this end, WB-6 was designed to incorporate the discovery made in testing of the closed box machine (i.e. a device whose coils were outside a closed vacuum box, and in which electrons could not recirculate), WB-5. Such prior testing by the applicant showed conclusively that electron losses can not be avoided due to B field penetrations of the box walls at the seams and corners of the structure, which result in direct impact paths for electrons which find themselves trapped in motion on these wall-intersecting B fields. That is, no practical way to cover ALL of such a box surface with protective B fields is apparent. Electron losses due to this effect would add another term to Gmj; one to account for losses to a fractional area over which B fields intersected the structure. Simple analysis shows that the fractional area of such intercept that can be tolerated within the requirement for net fusion power is less than 1E-4 to 1E-5, well below the values allowed for the line cusp flow channel effect.

Thus WB-6 was designed and built with coil container shells that were conformal to the B field shapes produced by the coils so contained, thus eliminating the electron-intercepting corners of the rectangular cross-section coil containers used in several prior machines. It was also designed with a significant spacing between coils at their otherwise-touching corners, so as to eliminate any direct B field intersection with container surfaces at these positions, and thus to prevent any direct electron transport along field lines into the metal. The spacing was chosen to provide electron gyro radii at the line cusp center plane of about ⅓ the spacing between coils. Larger spacing would reduce wall impact probabilities but only at the price of increased line cusp channel flow, with larger fractional line cusp area contribution, and thus lower values of Gmj.

The machine was held at high positive potential, to act as an electron attractor for emission from the emitters which were placed on four corners of the configuration (on triangular corners of the truncated cube, approximated using circular coils, as in previous WB/MG machines). The emitters (which were each simply an array of tungsten headlight filaments) were also held at ground potential; thus the only element in the machine system not at ground was the WB-6 device, itself, into which electrons were injected from the emitters spaced a short distance from the device, and on-axis of the corner cusps. The emitter standoff distance was kept approximately equal to the mean radius of the cusp face through which they were injected. This minimized electrostatic “droop” in the potential well at these corners, yet gave sufficient potential field gradient to provide good extraction from the filaments.

The electrons thus injected at the high energy of the device positive potential, then ionized the fusion fuel deuterium (D2) gas that was next injected, into the interior of the system, through a small tube leading directly into the edge of a cusp face. This was done to attempt to keep the neutral gas density inside the machine higher than that outside, during its very short time of initial operation, while the external gas pressure—hopefully—remained low (to prevent arcing) for a short period until the outflow of injected gas filled the main vacuum tank. The residence time of neutral gas atoms in the machine is about 0.3 msec, thus gas not ionized in this time will escape into the space surrounding the device, between the device and the Faraday cage (screen) external to the machine, which provides a spatially congruent electric potential (at ground) for the test.

Energetic electrons injected into this neutral gas buildup ionizes some of this gas, with an ionization time of about 0.3-0.5 msec, producing ions of D. These then begin to fall into the potential well—as it forms—along its electrostatic field gradients. Ionization was, in the first moment of injection of electrons, done solely by the fast injected electrons. However, the electron/ion density thus produced (initially only by fast electron ionization) was too low to satisfy the beta=one condition, and many of the neutral atoms escaped without ionization.

However, as this initial ionization proceeded, the low energy electrons (at ca. 100 eV) produced by such ionization of each neutral atom of D, then collided with other D atoms, and ionized them in an exponentially-growing cascade. This is especially important to note, because the cross-section for ionization by low energy electrons is much larger than by fast electrons (e.g. at the injection energy of ca. 12-12.5 keV). At low energy the cross-section is approximately (σizn)=1E-16 cm², while at the high drive energy of injection the cross section is of order 0.3-1E-17 cm². The e-folding time for this cascade is about 2 usec (microsec). Since the stable density attainable by the injected electrons is only about 1E9/cm³, while the neutral gas density is in the range of 2-5E12/cm³, the cascade must increase the electron density by roughly 4000× to reach nearly total ionization. This is only about 9 e-foldings, thus the entire secondary low-energy ionization process requires only about 20 usec to complete.

As this process proceeded, the increasing and large density of initially-low-energy (i.e. “cold”) electrons thus produced was “heated” by (the very rapid) collisions with incoming fast injected electrons. The electron/electron energy exchange collision time in the ionizing plasma is of the order of 1-2 usec, so that the “cold” electrons are readily “heated” by collision with the incoming injected electrons. The energy required to excite and energize the initially “cold” electrons resulting from the first “fast” electron ionization, is supplied by the incoming injected electron current, however, the total rate at which this can occur is limited by the input power of the injected beam. Thus the increasing density of initially-cold electrons will rise until a power balance is reached. Analysis of this process shows that injection currents of 10-40 A, at the injection energy of 12-12.5 kV, provides enough power to yield almost complete ionization of the neutral D gas (by this two-step—cold/hot—process) at a density of ca. 0.5-1E13/cm³, equivalent to a pressure (at STP) of about 3E-4 torr.

At these currents the complete ionization process takes place in less than 0.5 msec, by which time the electrons will nearly all be at the injection energy, because of the rapid 1-2 usec heating by electron/electron collisions during the process. With full ionization of the internal fill gas, the beta=one condition is reached (first with cold electrons) and maintained, as all the electrons are driven to injection energies by electron/electron collisions. The potential well is maintained, and the ions thus produced are able to make fusion reactions at or near the center of the well, by colliding with other ions at the bottom of the well

Measured data from these tests shows DD fusion neutron production of about 5E4 neutrons over a period of about 0.2 msec (less than the data rate interval), which also shows the emitter current of injected electrons to run at about 4-40 A during this short pulse period of fusion generation. This peak pulse period is also indicated by light output measurements from the photomultiplier tube detectors. The PMT showed a rise to peak output as the internal machine neutral gas was fully ionized, a flat-top during the onset of the external glow discharge, and a rapid falloff as this condition was passed. The actual rise was certainly faster than the data rate showed, so that at the peak, the edge electron density was a maximum, the full well depth was established, and DD fusion was taking place. Beyond this time, the potential on the machine dropped as external arcing (from the tank walls and feedthroughs) took over, the external current rose to very high values, and the system discharged and shut down.

As the fill process proceeded, a lesser fraction of the neutral gas injection leaked out of the machine to the tank, however the tank pressure continued to rise. Since continued inflow of neutral gas from the pulsed supply could not be stopped in a fraction of a msec, gas flooded from the machine, both before and after the beta=one condition was reached and filled the main vacuum tank within a few msec. This simply continued the tank wall arcing that started almost as soon as the well was formed, and the tank pressure continued to rise sufficiently so that the external arcing outside the machine system continued as well. This took place between the input leads carrying power to the device itself, and the tank walls and sharp corners surrounding these leads. These leads were not electrically shielded or insulated, so were able to arc with electrons from the large area of surrounding tank metal. The Paschen arc condition here was dominated by the edges and corners of the tank wall reentrant structure at the feedthrough positions.

The current measuring devices used to measure emitter current all measured this current with respect to ground. The emitter current channel was independent of that used for the external current measurement (which showed the currents due to glow discharge and arcing). Thus the emitter current was correctly measured as was the external “dumping” currents, recorded as rising to over 4000 A, following the deep well production, beta=one condition.

As noted above, tests were run in a completely transient mode, with puff gas input, emitter/extractor potentials supplied by pulsed electric drive from large capacitor banks, and with pulsed magnet currents, as well. In this method of testing, proper timing is the key to success of the tests. The capacitor drive on the emitters/machine potentials was turned on first, by means of a fast-acting pneumatic-driven copper block switch, with the background gas pressure kept low, at ca, 1E-7 torr, to avoid arcing in the system. At this pressure, the emission was very small so that the caps did not discharge rapidly. Then the D gas was injected by a fast-acting (ca. 0.5-1 msec) solenoid valve, that opened the line from the gas chamber at 300 mtorr to the interior of the machine. The gas was stored in a small finite volume (ca. 8 cm³) of tubing, upstream of the machine. This caused the pressure and gas density to rise within the machine interior, with a rise time of about 0.3-0.5 msec. Fast injected electrons then ionized the gas as it reached its high density state, with consequent cascade ionization, as described above.

As this process proceeded, neutral gas unavoidably leaked out of the machine into the main vacuum tank, causing the pressure external to the machine to rise. Its leak rate was also on a time scale of about 0.3-0.5 msec. Since the tank volume was about 300 times larger than the volume of the WB-6 device, itself, the rise rate was correspondingly reduced. Initially the leaking gas filled the space between the machine and its Faraday cage, which was only about 6 times the machine volume. Thus glow discharge could take place in this region before the full tank was filled.

However, Paschen arcing will occur in the external regions of the system if the external pressure/density rises above about 3E-6 torr. Starting at 1E-7 torr, thus gives a rise factor of only about 30 for the avoidance of Paschen arcing in the entire external regions. Such arcing will—of course—shut the system down by causing a massive discharge of the capacitor bank into the arcs so formed. Since the pressure/density rise inside the machine must be from 1E-7 to 3E-4 torr equivalent, or about 3000×, while that allowed externally to avoid arcing is ca. 30×, the factor of 300 in external volume (above) allows about 3 msec to reach and hold internal test conditions desired for fusion in this test system. The initial glow discharge in the machine/cage space required far less time. These were found to be reached in ca. 0.5 msec, beyond which the continued inflow of neutral gas does flood the tank and lead to external arcing, largely from tank power input leads to the tank walls themselves.

Before running at high drive voltages, it was useful to test for electron transport in this configuration. Since a key variable in such tests is the electron density at the machine inner edge, and there was no way available to measure this density directly in the testing conducted, it was noted that the density could be determined with precision if the machine could be run at the beta=one condition. This is evident from the formula for plasma electron beta: Beta=(8pi)(ne)(Ei)/B̂2. If run at beta=one, with known drive voltage/energy Ei and known B field strength, the density will be uniquely determined. The beta=one condition can be measured by PMT data, which will always peak when the electron density reaches its maximum, which occurs only when this is achieved. Thus, if Ei is fixed, and the B field is swept from zero to a high value, it will always pass through the beta=one condition. At this point the density will be calculable, thus the electron transport coefficient in the MG transport equation can be determined for this point.

Tests were made at low drive voltages with B fields sweeping from zero to several kG, to test for electron transport across the confining magnetic fields. By sweeping the B field of the machine, the range of plasma/electron “beta” was varied from infinity (at B=0) to very small values (as B−>kG). In this sweep, it was inevitable that a value of B was reached at which plasma beta was equal to unity. At this condition, the electron density reached its maximum value, as this is the best that can be done by B fields to confine charged particles. This is easy to detect by use of light intensity measurements detecting electron/neutral ionization and subsequent recombination collision effects in the system. Accordingly, a photomultiplier tube (PMT) detector was used to measure light output as the B field was swept through its range. About 30 tests were made in this fashion.

With the edge density thus determined, it is possible to calculate the coefficient (Kj) in the simplistic single-term electron cross-field transport equation, as derived from tests stretching from WB-2 through WB-4. This is

Ie=Kj(Asurf)(Ei)(SQRT(n))/B̂(¾)

where Ie is electron current in Amps, (Asurf) is the surface area of the machine, and other terms are as before. Results of these beta=one tests showed greatly improved confinement of electrons (by 10-20×) from prior work, and determined the overall transport coefficient in the simplistic one-term MaGrid transport equation to be much smaller than was found in earlier tests with prior machines. Typically Kj=2-4E-12 for E in eV and B in G. This showed the efficacy of the WB-6 design in reducing electron losses in Polywell systems. These results also offered convincing proof that the actual transport of electrons across the B fields is only one component of the two-term loss channel mechanism discussed previously.

This mechanism involves both direct cross-field transport to the coil container surfaces (as cited above), and losses to the less well-shielded surface areas at, for example, the coil/coil corner regions and/or to the edges of square coil boxes as used in earlier machines. In prior devices (WB-2, 3 and 4), the coils touched at the corners, and this gave a direct loss area into the metal surface at these points, as the B fields went directly into the metal here. In WB-6 these corners were separated to avoid this problem, but less well-shielded interconnects still existed between coils, which offered higher loss flux regions than for the direct cross-field transport to the B-field-conformal coil containers.

Losses to these less-well-shielded surfaces can be calculated (in the fashion of the enhancement of flow losses at the corners) as the product of the local density (nlocal) at the surface, the electron speed (ve), and the fractional area (funsh) of the lossy surfaces relative to the total loss area of the machine. The local density is given by the interior edge density (ne) reduced by the square root of the internal Gwb factor, to account for the interconnect position outside the magnetic field mid-plane. This gives an equation for such losses in WB-6, as

Iunsh=(funsh)(ne)(ve)/4{SQRT(Gwb)]((ks)

Where (ks)=2(pi) E18 charges/sec per Coulomb, for Iunsh in Amps.

When the device is operating at beta=one, the inner edge density is just that from the pressure balance equation

(ne)(keEe)=(beta)(B̂2)/8(pi)

where (ke)=1.6E-12 ergs/eV, for Ee in eV, B in G, and ne in electrons/cm̂3.

Taking these together, noting that Gwb=(BR)̂2/110Ee in the truncated cube system, and reducing, gives the current Iunsh as

Iunsh=1.05(funsh)(B/R)

From this it is evident that the fraction of unshielded metal that can be tolerated for loss currents in the range of a few Amps, must be the order of funsh <0.05 (5% of total surface area), or so.

It was only possible to test WB-6 at conditions of interest for fusion for a few tests; four times at electron drive voltages (and consequent well depths) that might produce fusion. Drive energies were 12-12.5 keV, and well depths were at ca. 10 keV. These final tests all did produce measureable neutron counts, an indication of DD fusion.

Data from prior tests revealed the current at which the well depths and densities were those desired for fusion, and at which fusion occurred. Neutron counts were all obtained in a period less than 0.3 msec (the time scale of the data is on 0.5 msec intervals), and analysis shows that the fusion operating condition was only about 0.2 msec. For this operating period, the data show that the fusion rates produced in these tests were very large, typically at about 1E9 DD fusions/sec. This is over 100,000 times larger than results obtained in the much earlier work by Farnsworth/Hirsch at similar drive conditions.

### CONCLUSION

In general, the large gain (G) of the systems described above, even at small sizes (see Table 1), makes their application to systems of modest size and scale quite straightforward. For example, in the experimental results described above, a fusion reaction rate of 1×10⁹/s has been obtained in a small device of only 15 cm radius with a 10 kV electron driver and a 1 kG magnetic field. Since the fusion can only take place at the core of the device (this is because ions need to gain energy from the electrostatic potential well as they converge to the core), it is possible to estimate the ion density at the core from this fusion rate as nᵢ²<σv>*Volume=1×10⁹ fusion reactions/s.

Here, one assumes that the core volume of the potential well where the ion energy reaches a fusion relevant level of ˜10 kV to be 1.5 cm, or 1/10^{th} of the device size. Furthermore, one estimates the <σv> term assuming mono-energetic colliding beam fusions with the center of mass energy of 20 kV. Since this is the maximum possible center of mass energy for two colliding beams in a 10 kV potential well (again the maximum potential well possible with 10 kV electron beam driver), one will overestimate the fusion reactivity, thus underestimate the ion density. In this case, one obtains the ion density in the central region to conservatively be ˜4×10¹³ cm⁻³. This is a very high density for a small test device and clearly demonstrates the ability of the above described type fusion devices to operate at a higher plasma density than most other fusion devices known or proposed in the art.

In reactor scenarios such as those described above, the device size would be ˜3 m in diameter with up to 5T of magnetic fields (10T for super conducting coils) and in excess of 100 kV of applied voltage. The β=1 boundary condition dictates that the edge density would be 2500 times higher than what was observed in the WB-6 experimental device. Using the similarity of the plasma density profile (assuming nothing better than what has already been achieved), the estimated ion density in the core region would be ˜1×10¹⁷/cc for even the 5T case.

Furthermore, using the measured current of 800 A, the injected electron energy of 10 keV and the edge density calculated from the β=1 constraint, one finds that an electron traverses the Polywell ˜16800 times (compared to a value of 10-15 for gridded systems known in the art) before colliding with an electrode. This leads to an electron lifetime for the WB-6 device of ˜85 μsec. Given that the electron lifetime scales like B²a³/E^{3/2} (see, e.g., N. A. Krall, Fusion Technology 22, 42 (1992)) where B is the magnetic field, a is the device radius and E is the injected electron energy, simple empirical scaling from the present device gives electron lifetimes of 6.72 sec for the 3m, 5T device discussed above, which is more than adequate with a large margin for error. Thus, systems of the type described above need not operate with absolutely perfectly conformal surfaces, thereby allowing for practical, scalable designs (e.g., designs, as described above, where the cross-section of the containers and parts thereof are conformal to the resulting B field that is produced except at the portions that connect with each other).

It is also noteworthy that for the systems described above, there is no need for complex external magnetic coils in order to create for example, immersed current carrying conductors inside the plasma as found in some devices known in the art. As demonstrated in the examples above, Polywell type devices operate at a high plasma density, thus a small but finite electron loss can be tolerated. This also relaxes the critical condition of “perfectly conformal surface”. For example, as described above, in various embodiments, a device may consist of 6 ring coils held together by metal joints and with mechanical support structure without any additional external coils, again allowing for practical, scalable designs.

In fact, the smallest radiation-free systems described above could be used for a variety of civil applications on a local level; e.g., power units for large-scale housing developments, clusters of manufacturing plants, etc. Other civil/commercial applications are obvious for radiation-free systems; including ship propulsion, prime power for railroad engines, and selected steam-generating and/or electric power production plants. These are in addition to the applications noted above.

It is worth noting that the basic device, as conceived, is not an “ignition” device in which a certain set of conditions must be achieved in order that the fusion reactions will become self-sustaining. Rather it is inherently a power amplifier, in which (small) electric power is provided to the magnetic field coils and electron and ion injectors of the system, and (large) fusion reaction powers are induced and caused to continue steadily and stably within the machine's confined plasma volume. This feature is a natural result of the facts that: (a) electrons have gyro radii much smaller than the device radii; (b) fusion fuel ions have gyro radii comparable to the device radii, and; (c) fusion products have gyro radii much larger than the device radii. All of this ensures that: (a) electrons will be well-trapped by the magnetic fields of the device; (b) plasma ions will not be trapped by these fields but, rather, by the electrostatic fields set up by the trapped electrons, and; (c) fusion product ions (e.g., He4, He3, T, etc.), with multi-Mev energies, will simply escape from the system entirely, carrying their energy with them. Because of this latter feature, the device may exhibit an “ignition-like” property, in which the initiation of significant fusion reactions can result in the ejection of large numbers of positive charges which, in turn, increase the fusion reaction rate by deepening the electrostatic well confining the fusion reactive plasma.

The richness and diversity of fuels and processes for fusion power production offered by this new and novel means of confinement and of adding energy to plasmas and charged particles offers many new possibilities for unique applications to conventional and non-conventional energy plants. In addition, entirely new types of energy/power systems for civil/commercial, space, and military uses are made possible by this device.

It will be apparent that the broad teachings of embodiments of the present invention can be profitably applied to specific embodiments and applications far beyond what is set forth above for the purposes of illustration. The present invention should therefore not be in any way deemed limited to such specific embodiments and applications, but should instead be deemed fully commensurate in scope with the following claims.

What is claimed is:

1. A method of confining positively charged particles comprising the steps of:
(a) generating a magnetic field within a region wherein all the cusps of said magnetic field are point cusps;
(b) injecting electrons within said region and using said generated magnetic field to confine electrons within said region and so to generate a negative potential well;
(c) performing at least one of injecting positively charged particles into said region or creating positively charged particles within said region, and using said negative potential well to confine said positively charged particles within said region;
(d) maintaining the number of electrons greater than the number of positively charged particles; and
wherein said step (a) further comprises utilizing a plurality of coil structures, each of said plurality of coil structures having coils for carrying current and a corresponding plurality of containers which house said coils, each of said plurality of containers having a cross sectional shape conformal to the B field produced by said coils, said plurality of coil structures arranged relative to one another so as to lie on at least some faces of a polyhedron at positions spaced from and adjacent to edges of said polyhedron, said polyhedron having an even number of faces about each vertex, and
wherein said plurality of containers are spaced apart from one another at vertices of said polyhedron.

2. An apparatus for controlling positively charged particles comprising:
means for generating a magnetic field within a region, all the cusps of said magnetic field being point cusps;
means for injecting electrons into the center of said region for forming a negative potential well within said region;
means for performing at least one of injecting positively charged particles into said region or creating positively charged particles within said region, and using said negative potential well to confine said positively charged particles within said region; and
means for maintaining the number of electrons greater than the number of positively charged particles;
wherein said magnetic field generating means includes current carrying means for carrying an electric current, said current carrying means so arranged as to lie on at least some faces of a polyhedron and spaced from and adjacent to edges of said polyhedron and spaced apart at each vertex of said polyhedron, said polyhedron having an even number of faces about each vertex;
wherein said magnetic field generating means generates only point cusps at positions corresponding to the centers of faces of said polyhedron; and
wherein said electron injecting means is arranged to inject said electrons through one of said point cusps along a first line corresponding to an axis of said polyhedron.

3. An apparatus as claimed in claim 2 further comprising a second electron injection means arranged opposed to said first mentioned electron injection means across said magnetic field generating means.

4. An apparatus as claimed in claim 2 wherein said means for injecting electrons includes means for generating an electron beam with rotation.

5. A device for producing collisional reactions comprising:
(a) means for generating a magnetic field within a region, said means including magnetic field coils arranged so as to lie on at least some faces of a polyhedron and positioned spaced from and adjacent to edges of said polyhedron and spaced apart at each vertex of said polyhedron by a spacing distance, each vertex of said polyhedral being surrounded by an even number of faces, said field coils carrying currents such that adjacent faces of said polyhedral have opposing magnetic polarities,
(b) means for injecting electrons within said region, said electrons having gyro radii effectively smaller than the radius of said region such that said electrons are trapped within said region by said magnetic field, said trapped electrons forming a negative potential well within a volume of said region;
(c) means for performing at least one of injecting positively charged ions into said region or for producing positively charged ions within said region, said ions having gyro radii effectively larger than a radius of said region when at their maximum energy within the potential well, such that said positively charged ions are not trapped within said region by said magnetic field, said positively charged ions being confined within said region by electric potential gradient forces resulting from said negative potential well, the number of electrons within said region maintained larger than the number of said positively charged ions, and said positively charged ions having energies sufficiently great within said region to produce collisional reactions; and
wherein said field coils are contained within a housing which has a cross sectional shape conformal to the B field produced by said field coils.

6. A device as recited in claim 5 wherein said spacing distance is approximately 3-10 electron gyro radii.

7. A device as recited in claim 5 wherein said gyro radii of said electrons are on the order of 0.5-5 mm at energies of about 20-50 kev in a magnetic field of 1-5 kilogauss.

8. A device as recited in claim 5 wherein said polyhedron has at least some square faces and said coils form a square in plan view corresponding to said square faces of said polyhedron.

9. A device as recited in claim 5 wherein said ions are selected from isotopes of an element taken from the group consisting of lithium, beryllium, helium, boron and hydrogen.

10. A device as recited in claim 5 further including means positioned outside of said region for converting energy resulting from said reactions into one of thermal and electrical energy.

11. A method for producing collisional reactions comprising the steps of:
(a) generating a magnetic field within a region by passing current through a plurality of magnetic field coils positioned relative to one another so as to lie on at least some faces of a polyhedral structure, said coils positioned adjacent the edges of said polyhedral structure, each vertex of said polyhedral structure being surrounded by an even number of faces,
(b) injecting electrons within said region, said electrons having gyro radii effectively smaller than a radius of said region such that said electrons are trapped within said region by said magnetic field, said trapped electrons forming a negative potential well within a volume of said region; and
(c) performing at least one of injecting positively charged particles into said region or creating positively charged particles within said region, said ions having gyro radii effectively larger than said radius of said region, when at their maximum energy within the potential well, such that said positively charged ions are not trapped within said region by said magnetic field, said positively charged ions confined within said region by electric potential gradient forces resulting from said negative potential well, the number of electrons within said region maintained larger than the number of said positively charged ions, and said positively charged ions having energies sufficiently great within said region to produce collisional reactions, and
wherein said plurality of field coils are contained within a corresponding plurality of containers, each of which has a cross sectional shape conformal to the B field produced by said plurality of field coils; and
wherein said plurality of containers are spaced apart by a spacing distance at corners of said polyhedral structure.

12. A method as recited in claim 11 wherein said gyro radii of said electrons are on the order of 10-100 times smaller than a diameter of said region.

13. A method as recited in claim 11 wherein said spacing distance is approximately 3-10 electron gyro radii.

14. A method as recited in claim 11 wherein said polyhedral structure has at least some square faces and said coils form a square in plan view corresponding to said square faces of said polyhedral structure.

15. A method as recited in claim 11 wherein said ions are selected from isotopes of an element taken from the group consisting of lithium, beryllium, helium, boron and hydrogen.

16. A method as recited in claim 11 wherein said electrons are injected at energies producing a sufficiently large negative potential well so as to cause nuclear fusion reactions among said positively charged ions.

17. A method as recited in claim 11 further including the step of converting energy resulting from said reactions into one of thermal or electrical energy.

18. A method as recited in claim 11 further including the step of continuously increasing the number of electrons in said region to compensate for electron losses.
